(19) United States
(12) Patent Application Publication
(10) Pub. No.: US 2006/0020496 A1
(43) Pub. Date: Jan. 26, 2006

(54) Process for scheduling charter transportation

(76) Inventors: Michael Richard Azzarello, Thousand Oaks, CA (US); Daniel George Harvey JR., Monrovia, CA (US); Ben Joseph Barbosa, West Lake, CA (US)

Correspondence Address: Michael R. Azzarello, 805 Paseo Del Robledo, Thousand Oaks, CA, 91360, US

(21) Appl. No.: 11/150,990

(22) Filed: Jun. 13, 2005

Related U.S. Application Data
(60) Provisional application No. 60/580,782, filed on Jun. 17, 2004.

(51) Int. Cl. G06Q 10/00

(52) U.S. Cl. 705/5

(57) ABSTRACT

In an online system a passenger enters a trip, seeking an individual seat on a charter aircraft. Available charter operators and aircraft are selected from a database using scheduling and pricing algorithms to match the passenger's request to existing flights and newly created flights. The charter operator is alerted to the passenger request and requested to confirm their acceptance of the passenger's trip. The passenger receives a confirmation and a quote for the trip. The passenger is able to realize many of the benefits of charter travel at substantially lower prices.

### RELATED APPLICATIONS

This application claims the benefit of Provisional Application Ser. No. 60/580,782, filed Jun. 17, 2004, the entirety of which is hereby incorporated herein by reference.

### BACKGROUND OF THE INVENTION

The present invention relates to scheduling systems. More particularly, the present invention relates to transportation scheduling applications using digital and analog networks.

Computerized scheduling systems for transportation are well known, especially those scheduling systems used for air travel. These scheduling systems range from simple bulletin board systems that allow a passenger to “post a request” and “receive a quote” to large complex mainframe computer systems, like SABRE, used by airlines that integrate all of the operations of passenger travel into the system. All major airline travel is booked through computerized scheduling systems. An airline scheduling system's main goal is to generate optimum revenue from a fixed set of routes and flights. Advancements in the technology in airline systems include online access and improved pricing calculations to price fares for several different traveler profiles. For example, vacation travelers planning a trip several months in advance can purchase a ticket for substantially less than a business traveler who needs to travel within the next few days.

Scheduling systems enable the sale of other transportation services including, without limitation cargo space on an aircraft, passenger accommodations on a cruise ship, ferryboat and other vehicles. Scheduling systems are also used for other services, such as restaurants and hotel rooms.

Computerized scheduling systems for transportation services generally follow a process flow that requires them to have information on capacity, routes served, schedules for those routes and pricing information before a passenger can book a flight. The system performs a variety of functions including managing capacity like an inventory system for a distributor, quoting prices to potential users of the service, reserving the capacity requested by the passenger, binding the user by collecting payment, tracking delivery of the service, and reconciling any issues after the service has been delivered. These systems work well because a substantial amount of information about the service is known in advance.

Within the aircraft charter industry, a common method of reserving a charter flight is direct negotiation between the passenger and the charter operator. This can be in person, on the telephone, via email exchange or another form of communication. The charter industry is highly decentralized. A consolidated scheduling system, like SABRE, is not available for charter flights. What is available are best described as broker systems that operate on the Internet. These systems are very similar to the bulletin board systems that allow a traveler to request quotes for a charter flight. These systems operate as “middle-men” by taking a fee from the operator for matching the traveler to the operator. These systems take a traveler's request and return multiple quotes from several charter operators. The traveler then selects a charter operator from the list. The system quotes a price, but lacks important information for the trip such as availability of specific aircraft. The traveler coordinates directly with the charter operator on the details of the flight including aircraft availability, limitations on passengers and cargo, and costs for extra services such as wait time and refreshments. Once direct communication is established, the possibility exists that either the traveler or the operator approaches the other party with the intent to reduce the cost (traveler) or increase revenue (operator). Aircraft charter flights are very expensive in comparison to commercial airline travel, so a small percent change can equate to hundreds or thousands of dollars saved by the traveler or earned by the operator.

Prior to January 2004, charter operators could only charter an aircraft to one customer at a time. This reduced the complexity of scheduling for the operator by binding the entire aircraft to a single customer. The operator was not allowed to sell empty seats even if the customer allowed it. Operators could use very simple scheduling and pricing systems. For example, a paper based system that tracks if the aircraft is available at the requested time, then the operator quotes the hourly rate for the aircraft, wait time charges and incidental charges. This model worked since a charter operator is only delivering service to a single customer at any given time and the customer is charged for the “actual” flight time, making the cost open ended, in comparison to buying a ticket on an airline, which is fixed.

Changes in the Federal Aviation Administration (FAA) rules that regulate air charter travel were approved at the beginning of 2004. These rules allow the sale of individual seats on a charter aircraft. Limitations are the aircraft must have two engines or be turbine powered, have ten passenger seats or less and must depart or arrive at a non-airline hub airport. The Federal Aviation Regulations that regulate the air charter business are Part 135. The new rules are meant to increase air service to under serviced and non-serviced communities. There are over 5,000 general aviation airports in the US, with 93% of the population living within 30 minutes of one. In contrast, there are less than 500 airline hub airports with only 22% of the population living within 30 minutes of one. Of the hub airports served by airlines, 30 airports carry over 70% of airline traffic.

The existing airline scheduling systems do not meet the requirements for charter travel under the individual seat sale regulations. A major difference is the complexity of the transportation problem poised by individual seat sale charter. There is little known data in the individual seat sale charter model such as established routes, predetermined flights for the routes, and type of equipment used. The problem needs to account for the travel preferences of the passenger; one passenger may be more interested in setting a departure time, another is more interested in total travel time. These variables are fundamental to the benefits of charter travel.

Virtually no information is known about a charter flight before a passenger makes a request. This invalidates the designs of existing scheduling systems. The simple scheduling systems, like bulletin boards, do not provide a means to calculate fares, facilitate multi-leg or multi-operator trip requests or route optimization.

The individual seat sale charter requires a system that meets the needs of both passengers and operators in a new travel paradigm. The new charter service is a hybrid between charter travel and airline travel. Specific issues that need addressing in a system are point-to-point travel, shortened total travel time compared to airlines, less cost versus the previous charter model, and passengers dictating departure and arrival times. These variables represent the business benefits of individual seat sale charter compared to airlines. Existing scheduling systems show available seats on predetermined flights and the passenger selects a flight.

Individual seat sale charter involves a passenger requesting a flight and a charter operator(s) fulfilling that request. The new system must be able to consolidate passengers with unique flight plans into groups that can be serviced by charter flights. Several different operators may be required to meet the needs of one trip request by a passenger. The charter flights must be profitable for the operator, meet the requests of the passenger and be priced competitively with alternative travel options. The system needs to calculate optimized routes and the costs associated with these routes. For successful operation with the decentralized charter industry, the system requires data about the operators, their aircraft and operating information about the charter aircraft fleet.

The system, once it has consolidated passengers, operators, and flights, must test the route and flight solution against multiple sets of constraints. Following a general to specific hierarchy, these constraints involve FAA regulations governing charter operations, “best practices” charter business rules, aircraft operation constraints, operator specific constraints and passenger specific constraints. Examples of constraints include Air Traffic Control preferred routes called Victor Airways, FAA mandated crew work and rest time, operator regional coverage and overnight rules, aircraft capability, airport access limitations, passenger required departure time, number of intermediate stops allowed, cargo and baggage, and special needs requirements.

The individual seat sale charter scheduling process has unique issues because of the cost and regulations associated with operating charter aircraft. All aircraft have large fixed costs; capital acquisition costs, routine maintenance, storage, insurance and unplanned maintenance. Additionally, aircraft are expensive to operate per hour in direct operating costs; fuel, crew, oil, and reserves for maintenance and overhaul expenses.

For operators to embrace individual seat sale charter a low cost, low risk, easy to use system, which consistently provides incremental revenue is required. If the system does not produce sufficient incremental revenue to offset the added risk and expense of providing individual seat sale charter, the operator is better off chartering the entire aircraft and taking an opportunistic approach to individual seat sales. For passengers to adopt the service the cost needs to be substantially lower than “entire aircraft” charter costs. The cost should be competitive with airline travel when the total travel time is factored into the value proposition.

Other forms of transportation are similar to individual seat sale charter but lack the cost and complexity of air travel. One example is taxicabs, which operate in the on-demand and point-to-point basis. The low cost of operating a taxi allows waiting for a passenger at a consolidation location such as airport, hotel, or convention center. For passengers, taxi travel is typically requested in real-time. Sharing of cabs by distinct travelers is possible but difficult. It requires two or more travelers to request a cab at the same origination point, know the destination point of each traveler and then agree to share the cab, the route taken and cost allocation.

Another similar example is the airport shuttle services like Super Shuttle in Los Angeles, Calif. where the shuttle vans pick up several passengers at the airport for a general destination area, such as the West Valley of Los Angeles. The vans drop off their passengers in sequence as the vans reaches the passengers' various destinations. Passengers have little input as to how long the trip will take, since it is dependent on the total number of passengers in the van and the location of their destinations relative to the other passengers. The fee to a geographic region is usually fixed. This service is dependent on a known point, the airport, as either the origination or destination point.

The benefits provided by an efficient individual seat sale charter scheduling system are significant for passengers, charter operators and communities that lack adequate airline service. For passengers in areas not well serviced by airlines, their door-to-door travel time on airlines is excessive. Average current airline door-to-door travel time, measured as miles per hour, is slightly higher than what a car travels at freeway speeds. Looking at maps of the United States with airlines service, much of the United States has limited or poor airline travel service. The sponsors of the FAA amendment listed as their desired result improved air travel service to under or none serviced communities. With individual seat sale charter, passengers in these communities now have a better travel option, especially when total travel time is considered. For the communities themselves, improved air travel can improve the quality of life, making them more desirable. Businesses can operate farther away from major metropolitan areas without a travel penalty.

The operators of charter aircraft are under the same economic rules as other companies that operate capital equipment to provide a service. The operator must maximize the use of the asset to generate sufficient revenue to cover all fixed costs, direct operating costs and then make a profit. For the charter operator, getting more customers is imperative for long term success. In the current charter model of chartering the entire aircraft the premium to fly charter versus first class on an airline is several times the cost, in some cases over ten times. Individual seat sale charter offers charter operators an opportunity to increase revenue by selling empty seats on a flight. This model could allow the sum of the passenger fares to be greater than what an operator would otherwise charter the aircraft under the old model. Finally, charter operators realize an increase in the size of the market of passengers willing to use charter aircraft for their travel needs.

The FAA and the National Aeronautics and Space Administration (NASA) are teamed with the aviation industry and academia in a multi-year project to promote the re-architecture of the air traffic control system. The purpose of this is to address the congestion at airline hub airports. The expansion of these hubs is difficult, if possible. The project consists of several complementary parts. One is the Small Aircraft Transportation System (SATS). The concept is to use smaller, more efficient aircraft to transport passengers more like a limousine service, this is commonly referred to as jet-taxi. Several companies are building jets to fit in this new category, the Eclipse 500 and the Adams A700. These aircraft cost about one forth of the current competing aircraft and operate at one half the cost. Some of these aircraft will be available in 2006. As these aircraft proliferate, the cost effectiveness of air charter improves. This new class of aircraft requires a system to coordinate scheduling.

An obstacle for successful individual seat sale charter is how to use multiple operators for travel needs. A multi-leg trip might be better served by using multiple operators. For example, a business traveler needs to fly from Oxnard, California to Santa Clara, Calif., then on the next day to Bosman, Mont., then Chicago, Ill. and on the third day back to Oxnard, Calif. It does not make sense to have an Oxnard based operator fly a passenger from Santa Clara, Calif. to Bosman, Mont. and then to Chicago, Ill., and from Chicago to Oxnard. Without a system that has comprehensive visibility to flights and passengers, the requirement is on the passenger to build a flight plan by contacting multiple operators. A passenger will spend a significant amount of time to build an itinerary that meets his travel schedule and cost constraints. The passenger is also negotiating with several entities, so does not enjoy a “favored” customer status for buying a large trip.

For the operator, the coordination of multiple passengers with different flight plans also presents complex scheduling and pricing issues not encountered previously. The operator must know specific details about each passenger, such as travel time constraints and costs, in order to book additional customers. Without this information the operator is continuously requesting approval from existing passengers to modify the flight plan. Absent a scheduling system, operators and passengers maintain redundant, iterative communication to build effective flight plans. As the complexity and cost increase to find and book reservations, it detracts from the benefits of individual seat sale charter for the passenger. If the charter operator fails to manage passengers and flights effectively he risks flying segments at a loss.

The optimal implementation of individual seat sale charter is to combine the best parts of charter travel with airline travel; offer point-to-point travel, in an on-demand or on-request mode, with a dramatic reduction in door-to-door travel time compared to alternatives. The system should offer an easy and predictable method to book a flight with predictable costs. As mentioned earlier, existing transportation systems use models that require assumptions that do not apply in individual seat sale charter such as known routes, fixed schedules, standardized equipment, standard loads, price and costs.

An example is used to illustrate the benefits of a successful implementation of individual seat sale charter scheduling system. This example highlights some of the system challenges faced by the passenger and the operator. The example is a consultant that needs to meet with a key client. The issues facing both the passenger and charter operators are presented.

The passenger has a client in an area not will served by airlines. This example places the passenger in Thousand Oaks, Calif., a suburb north west of Los Angeles, Calif. The client is located in Modesto, Calif., in the central area of the state, close to Modesto airport. The driving distance is 340 miles, requiring about six hours of drive time with stops for fuel and rest. The passenger can book a commercial flight, but is required to travel through San Francisco International Airport. Travel time from “airport to airport” is three hours and 35 minutes. The “airport to airport” flight time on a charter aircraft is 40 minutes.

The door-to-door travel time of the three options are: about six hours for the car (assumes time for fuel and rest stops); 5 hours and 45 minutes for airline travel which includes commute time to Burbank airport and security time at the airport; one hour 20 minutes for the charter aircraft with commute time to the airport and the passenger arriving within 15 minutes of the planned departure time. This example is representative of the benefits of departing and arriving at a general aviation airport versus airline hub airports and point-to-point travel. For the passenger, the difference in travel times equates to allocating two travel days for driving or airline versus one day with charter travel.

The comparative costs for the three options are: with individual seat sale charter the cost would be about $700; the automobile trip would cost $119 using 0.35 cents per mile; the airline trip costs from $350 to $600 depending on when the flight is booked. A more complete comparison includes hotel costs for the automobile and airline options. If the passenger is a professional, the time savings should more than offset the premium paid for individual seat sale charter.

Individual seat sale charter offers tremendous opportunities to both passengers and operators. However, successful implementation is complex. The passenger in this example is assumed to have located a charter operator that had a flight on the same schedule. There are two companies at the airport in Camarillo, Calif. that provide charter service. The passenger could call each and present his request for a flight. If neither operator had a flight that matches the profile, the passenger must pay full aircraft charter or seek out other charter operators.

The complexity of individual seat sale charter scheduling eliminates the use of a heuristic approach by either the passenger or operator. A heuristic approach is sub-optimal because the number of variables, continuous changes and interrelationship required for successful implementation are beyond what a person can process and optimize on their own.

### SUMMARY OF THE INVENTION

In a preferred embodiment, the present invention provides a method and apparatus for a passenger seeking travel services to request a charter flight, receive a quote for all segments of the trip based on the individual seat sale aircraft charter regulations, book the flight, manage payment by passenger to operator, and monitor the buyer's satisfaction with the travel service. A valuable application of this service is providing economical charter service to passengers with a minimum investment in time and communication. The system provides a simple and efficient method for passengers to find charter operators to provide charter air travel.

The present invention facilitates a passenger in locating operators that have charter flights complementary to the passenger's itinerary, to disclose all relevant information about the passenger's itinerary that may impact the operator's pricing and delivery of the charter service, and reach mutually agreed price and terms. This is done without the passenger and operator having direct communication. The system also provides an efficient system for charter operators to find qualified passengers for flights.

In one embodiment of this invention a passenger who requires a charter flight accesses an on-line scheduling system located at a remote server. The scheduling system verifies the user's identification and account status and allows the user to generate a transportation request for submission to an operator. The transportation request includes information about the trip, the passenger and specific rules relevant to the passenger. For example, a typical transportation request might be transportation from Camarillo Airport in Camarillo, Calif. on May 1, 2004 to Modesto Airport in Modesto, Calif.. The required arrival time is 2 PM that same day and the return trip is desired for May 2, 2004 with a departure time of 4 PM or later. The request is for two passengers who have no special requirements, two suitcases and two carry-on bags. The request also provides the weight of each passenger. Other information forming part of the request might include if intermediate stops are allowed and how many.

This information is submitted to the scheduling system that computes a transportation “score” for the passenger, which is a computational reference of the critical flight data for the trip. The scheduling system uses the unique “score” assigned to the trip to search for a matching flight and to compute the fare for the passenger.

If there is an existing flight, the passenger is quoted a fare, including any variances from the passenger's original request, then the booking process is initiated.

If a matching flight does not exist, the scheduling system applies several route algorithms to locate an alternative flight that meets the requirements of the passenger. A fare is quoted, including any variances from the passenger's request, and the booking process is initiated.

Finally, if an existing flight or alternative flights do not exist, a new flight record is created. This record is used by the system to match other travel requests. The system can use historical data and forecasted flights to predict the probability of additional passengers and what the price per passenger will be.

When a flight is booked the scheduling system recalculates the flight segment database to verify that flights are optimized. The system adjusts or flags flights that may need adjustments. Continuous price calculations by the system allows quoting fares to new passengers in a timely manner.

If either the passenger or the operator rejects a proposed flight, the system uses a hierarchical resolution process to identify and resolve the reason for rejection. If a resolution is found, the result is resubmitted to the pricing engine and the flight is sent back to the passenger. If a rejection is not resolved, the passenger request is escalated to a customer service function.

The entire process is done on the Internet or through other electronic access to the scheduling system. The system minimizes the complexities of individual seat sale charter, by using an interface and communication similar to that of online airline scheduling systems, for both passenger and operator, so that each party is able to benefit from individual seat sale charter.

In another embodiment of the system, a passenger accesses the system as described above, and posts a general trip request. This embodiment is designed for passengers who need to go to a location within a date range, but want to limit their total travel time or cost. An example of this is a person who needs to visit with a customer sometime during the month of May. The passenger posts his flight request, but uses a date range instead of specific dates. In this manner, the passenger can limit the travel time and/or the cost he is willing to accept. The system accepts this request as a pending flight. When a flight is created that matches the passenger's requirements, the system notifies the passenger and starts the booking process.

Another embodiment of the system allows charter operators to post flights that are not in the system. This method benefits operators by giving them the potential to sell additional seats on a flight. An operator accesses the system on a remote server, is authenticated as an approved operator and the system then allows the operator to post a flight segment with all relevant information about the flight. The system tracks the operator's original passengers' request, even though the scheduling system did not initiate the flight, so that price decreases can be calculated and communicated to the existing passengers. The operators can reap the revenue benefit of individual seat sale charter, at no additional cost.

A further embodiment allows passengers to “browse” existing flights.

An additional embodiment of the system is designed to allow the management and sale of the entire flight capacity of an operator. In the previous embodiments there is an assumption that the operator is booking some flights and passengers without the use of the system. This embodiment is the most comprehensive form and includes the operator posting information about their aircraft, the geographic region they service and other information pertinent to the operator. The system is the only means for a passenger to book flights with the operator. This embodiment includes links from the operator's website directly to the scheduling system with a “private label” option.

Yet another embodiment of the present invention is based on ground transportation, such as a shuttle van or mini-bus. Using cellular technology for communication and GPS technology for location data, the system can provide passenger's with transportation service that match taxicabs for ‘on demand’ and ‘point to point’ benefits, but at lower costs than taxicabs. The same scheduling issues and transportation model complexities apply for scheduling and routing, however the system is dealing with travel requests that are made minutes and hours in advance, as opposed to days and week in advance for air charter. This embodiment also includes Personal Digital Assistant (PDA) access, including web enabled cell phones and wireless PDAs.

Another embodiment of the present invention allows the operator and the passenger to communicate with the system through alternative devices other than personal computers. These alternative devices include, but are not limited to, Personal Digital Assistants (PDAs) with communication capability, WiFi or G3 connections for example. The PDA is able to access the system via a computer program on the PDA or a web page designed specifically for PDAs. Another example of this is cell phones that support computer applications. These devices access the system through an application interface that accommodates the small screen format of an application enabled cell phone.

An additional embodiment allows operators or passengers to access the system through a voice response or interactive telephone response system. This uses an interactive telephone response system, such as what Accessline Communications provides. These systems use the telephone keypad to access and interact with the system. In a variation of this, voice response can be used as the interface. Voicegenie provides a system that interfaces a voice activated system with a database program. In this variation the operator or passenger access the system by speaking their requests.

The present invention is valuable because it facilitates a universal and consistent payment protocol for the operator. In one embodiment, the present invention provides operators payment via electronic funds transfers. The system collects payments from the passenger in a variety of ways, but delivers the payment in a consistent method to the operator.

In another embodiment of the present invention, the system manages the billing of passengers automatically. The passenger's payment is processed prior to the operator committing to the flight. The system accepts all standard consumer and business methods of payment including credit card, debit card, checking account, electronic fund transfers, and bank wire.

An advantage of the system is that little or no direct communication between the passenger and operator prior to the flight is required. Operators will be able to offer individual seat sale charter without additional overhead of reservation clerks. Passengers will be able to book flights across multiple operators without contacting and managing relationships with each operator.

Another benefit of the present invention is the authentication of the operator and the passenger. Using cryptography, the system can authenticate the identity of the parties. This provides confidence to both operator and passenger that the transaction being entered into for charter flight services is a legitimate one.

Another embodiment of the system includes the background security screen commonly done by airlines when a reservation is made. This includes access to the FBI Watch List and matching passenger names to the list.

The examples listed above are focused on the charter operator with airline-like scheduling convenience. The system also has the capacity to provide companies (not charter operators) with a “private airline” system. For example, a destination resort wants to offer travel from several hub airports to the resort. The system can be used to manage routes, passengers, flights and operators. This allows a high quality flight service to be offered by a resort, while avoiding the cost and risk of contracting directly with one charter operator. The scheduling capability of the system matches aircraft and mission, so the right equipment at the right price is fulfilling the requirements.

In another embodiment of the present invention, quality monitoring is provided. If the passenger is dissatisfied with the delivery of charter service, the system collects the complaint and initiates action on behalf of the passenger to resolve the issue with the operator. A database will track this information, allowing the system to rate operators and determine if an operator should remain as a recommended operator. The same is true for passengers. Operators can post complaints, allowing the system to resolve the complaint and collect information. If a passenger has a history of poor behavior, for example, the system may flag them as less desirable and inform the operator of this before requesting a commitment.

The present invention enjoys the advantage of not requiring proprietary software. The use of JAVA for the Internet version of the system makes it accessible from virtually any desktop computer used by consumers, such as Microsoft Windows, Apple Macintosh, UNIX and Linux systems. For access from devices other than personal computers, the system uses JAVA for devices, such as cell phones and PDAs. The system is also accessible from non-JAVA enabled devices, such as cell phones and telephones, via an interactive and voice response service. The power of a central controller to maintain schedules, billing, collection, authentication and communication makes the present invention an improvement over conventional systems which do not have such an arrangement of elements. By combining various arrangements of these elements into one system, the present invention makes the scheduling, pricing, billing and payment of individual seat sale charter service fast, simple, efficient and market competitive.

The advantages of the scheduling system are ease-of-use for the passenger to enter a flight request and view available flights on-line with associated fares. The passenger can book the trip on line, even if multiple operators are required to fulfill the request. For the operator, the cost to create incremental revenue from the individual seat sale charter business is almost zero. This presents an opportunity for the operator to drive additional revenue at almost 100% gross margin. All charter operators who participate in individual seat sale charter benefit from a growth in the market for their service.

The system's capability to track existing flights, costs associated with the flights, revenue generated from the flights and the continuous dynamic calculation of fare information allows the system to provide booking data real time. For passengers and operators the complex process of matching flights to demand, calculating costs and fares is now completely automated. The system is the central clearing house for individual seat sale charter, providing orders of magnitude efficiencies for both passengers and operators.

Operators may participate across a wide spectrum of involvement, from occasionally posting existing flights to the comprehensive model in which all flights are booked by the system. The system handles collection and payment of fares and is able to facilitate resolution of issues. The system does continuous planning for “canceled flight” scenarios using existing flights and capability from operators. This provides an immediate action plan if there is a canceled flight.

Other advantages of the system include the ability to track flights on the Internet. This includes security so passengers and their designated people can only view flights for that passenger. Flight data can be transmitted to designated persons to facilitate planning and logistics. Transmission can be via pager, email and text messages.

The system provides a means to provide a frequent traveler rewards program across a broad number of charter operators. This dramatically increases the value of such a program to the passenger.

The system also combines multi-leg flights across multiple operators to provide passengers with an optimal flight plan.

The system further promotes the use of new, more efficient aircraft to non-hub airports, improving the livelihood of individuals and relieving some of the congestion at airline hub airports.

Operators benefit from optimized flights because it maximizes their revenue and reduces the amount of re-positioning or non-revenue flight time. This provides operators who participate in the system with a competitive advantage over non-participating operators.

The present invention is beneficial to a wide variety of passengers with a wide variety of travel needs. For example, the present invention is useful for a passenger who wants to travel from Thousand Oaks, Calif. to Modesto, Calif. for a two hour meeting with a client. The passenger has a specific date, departure time and return time in mind and does not want to spend the night. In another example, the present invention is useful for a passenger who wants to visit with a supplier for a normal quarterly meeting and can hold the meeting anytime during the month of May. The supplier is located in Chico, Calif., which has very limited airline service. In another example, the present invention is useful for an operator booking a flight from his home base, Oxnard airport, to Bosman, Mont., three weeks out who desires to sell additional seats, with the permission of the main passenger. The main passenger approved the sale of additional seats, if it results in a decline in fare and does not increase the travel time more than 45 minutes, and the operator uses the present invention to locate additional passengers to sell seats to who are traveling within the flights constraints. In a further example, an operator is planning to invest in additional aircraft for his charter fleet, but is concerned about driving enough business to make the purchase profitable. The present invention eases the concerns the operator may have regarding increased overhead related to a sales and reservation department to manage the individual seat sale charter.

### BRIEF DESCRIPTION OF THE DRAWINGS

The accompanying drawings illustrate the invention. In such drawings:

FIGS. 1A-1C illustrate a first embodiment of the present invention;

FIG. 2 is a block diagram showing one embodiment of the central controller;

FIG. 3 illustrates an embodiment in which the computing resources of the central controller are consolidated in a single server;

FIG. 4 illustrates an embodiment in which the computing resources of the central controller are distributed over a number of servers;

FIG. 5 is a block diagram showing an exemplary operator or passenger interface with a Personal Computer;

FIG. 6 is a block diagram showing a Personal Digital Assistant interface;

FIG. 7 illustrates an embodiment showing a passenger travel request being generated;

FIG. 8 illustrates an embodiment of the exception alert that collects data and transmits it to the Customer Service System;

FIG. 9 illustrates an embodiment of collecting rejection reasons;

FIG. 10 illustrates an embodiment of transmitting a fare quote and basic flight information to a passenger;

FIG. 11 illustrates an embodiment of transmitting the travel request to the appropriate operator;

FIG. 12 illustrates an embodiment showing the processing of a passenger score for scheduling and pricing;

FIG. 13 illustrates an embodiment showing the search for existing flight and computation of alternative flights options;

FIG. 14 illustrates an embodiment showing the creation of a new flight segment;

FIG. 15 illustrates an embodiment showing the computation of unique passenger fare;

FIG. 16 illustrates an exemplary compensation method employing credit card payment;

FIG. 17 illustrates one embodiment of customer confirmation to accept the flight and fare;

FIG. 18 illustrates one embodiment of operator confirmation to accept the flight and fare;

FIG. 19 illustrates one embodiment of analyzing and resolving rejection reasons;

FIG. 20 illustrates one embodiment of computing a canceled flight contingency plan;

FIG. 21 illustrates an exemplary embodiment for allowing passengers to browse and select flights;

FIG. 22 illustrates an exemplary embodiment for billing passengers;

FIG. 23 illustrates an exemplary embodiment for paying operators;

FIG. 24 illustrates one embodiment for preparing and transmitting the flight itinerary to passengers and operators;

FIG. 25 illustrates one embodiment to search for passengers that have a pending flight request when a new flight segment is added; and

FIG. 26 illustrates one embodiment of the process of booking the flight.

### DETAILED DESCRIPTION OF THE PREFERRED EMBODIMENTS

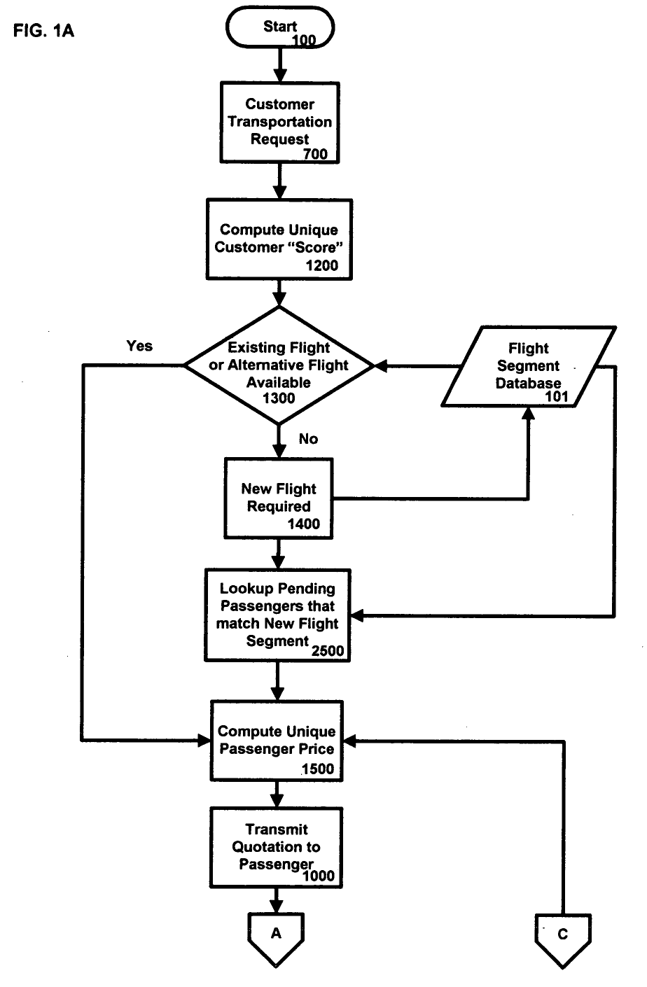

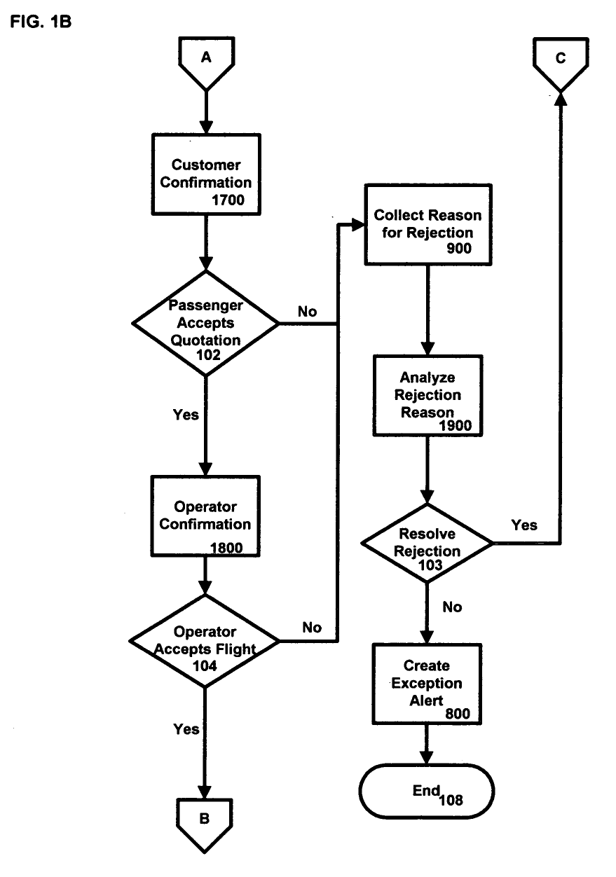

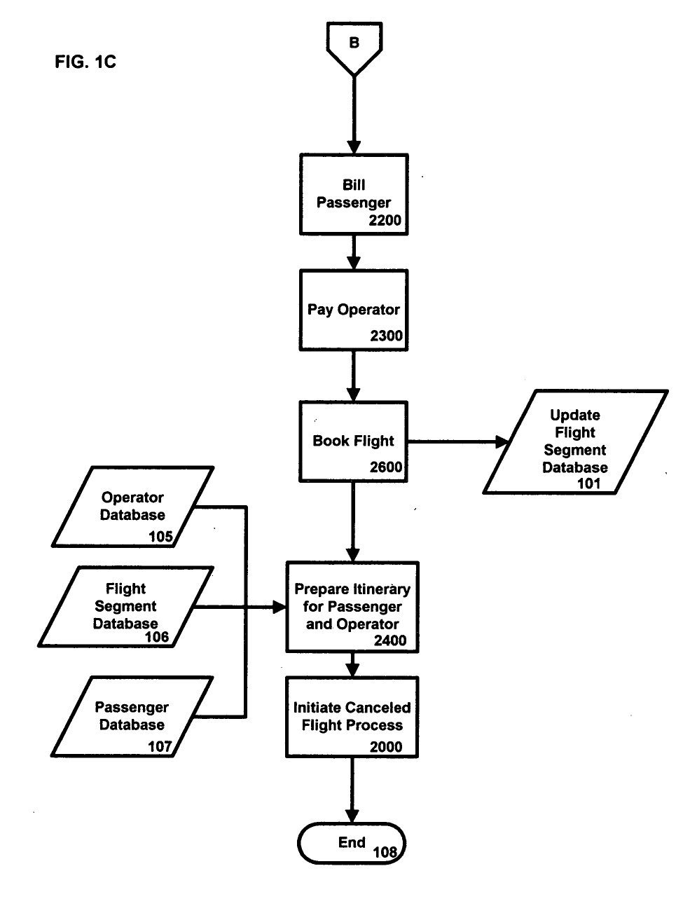

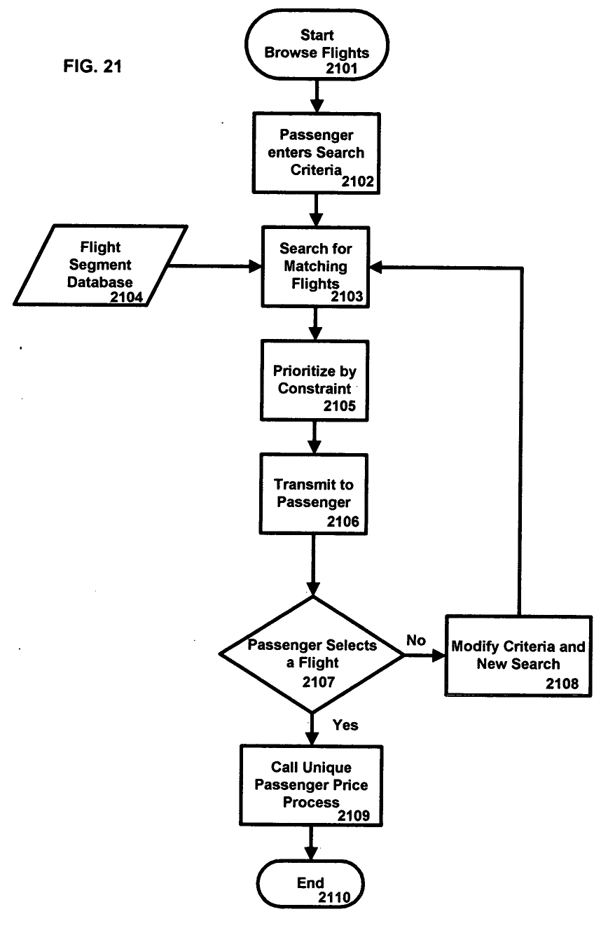

As illustrated in FIGS. 1-26, the present invention resides in an apparatus and method for scheduling charter transportation. The present invention identifies an appropriate charter operator(s), supervises the scheduling of requests to the appropriate operator(s), and supplies timely answers to passengers desiring to travel and schedule transportation with the operator(s). Thus, a person looking for charter travel can locate it in a simple, cost and time effective manner.

System Architecture

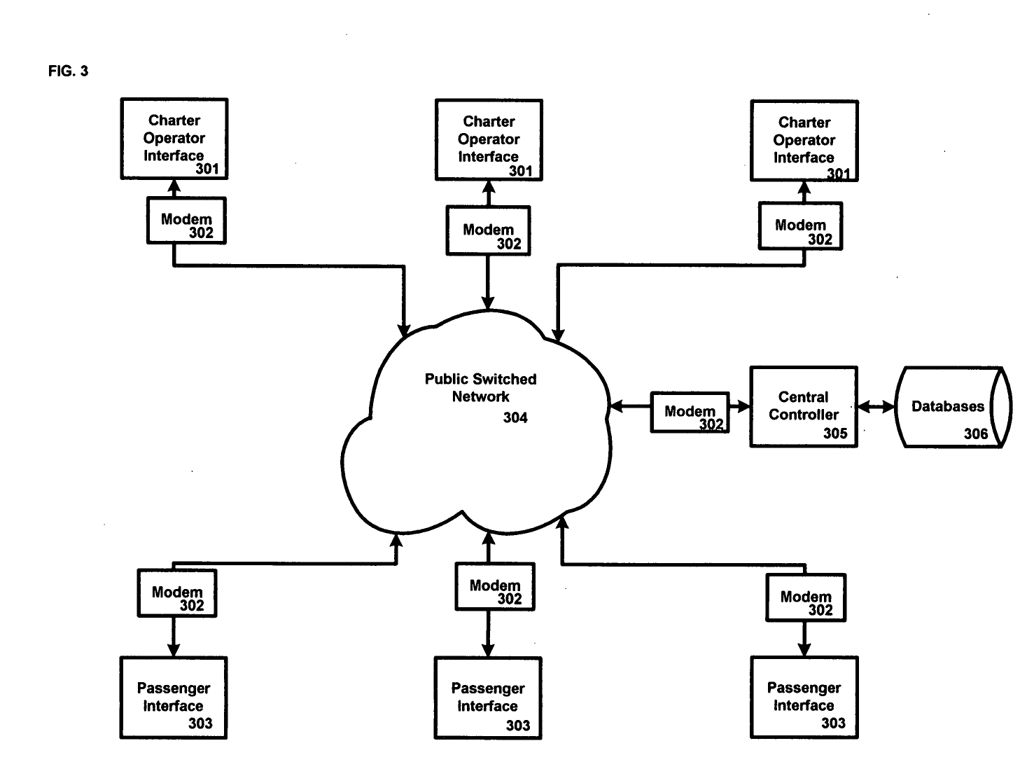

The system architecture of a first embodiment of the apparatus and method of the present invention is illustrated with reference to FIGS. 1 through 5. As shown in FIG. 3, the apparatus of the present invention comprises charter operator interface 301, central controller 305, and passenger interface 303 (collectively the “nodes”). There are also associated databases 306 connected to the central controller 305.

Each node is connected via an Internet connection using a modem 302 or the like and a public switched phone network 304, such as those provided by a local or regional telephone operating company. Connection may also be provided by dedicated data lines, cellular, Personal Communication Systems (“PCS”), microwave, cable networks, wireless networks or satellite networks. Charter operator interface 301 and passenger 303 are the input and output gateways for communications with central controller 305.

Using the above components, an overview of the present invention is shown in FIGS. 1A-1C. A method and apparatus is provided to receive transportation that starts 100 with a passenger requesting a charter that requires flight analysis 700, flight scheduling analysis and computation through a “score” method 1200, locating an existing flight or alternative flight that matches the request 1300, creating a new flight if an alternative does not exist 1400, checking and updating a flight segment database 101, looking up pending passengers that can be matched to the new flight segment 2500, computing fares for the passenger initiating the travel request and any existing passengers 1500, transmitting the quote to the passenger(s) 1000, receiving confirmation and acceptance by the passenger of the charter quote 1700 and 102, confirming the flight with the charter operator 1800, the acceptance of the flight by the charter operator 104, billing the passenger 2200, paying the operator 2300, booking the flight 2600, and preparing and transmitting the final itinerary to passenger and operator 2400, based on information in the operator, flight segment and passenger databases 105, 106, 107. The scheduling does not end 108 without accommodating exceptions, variations and rejections of computed flights by both operators and passengers 900, 1900, 103, 800 or initiating a canceled flight process 2000 if necessary. Through the method and apparatus of the present invention, passengers can efficiently request charter flights from charter operators based on an individual seat sale charter model.

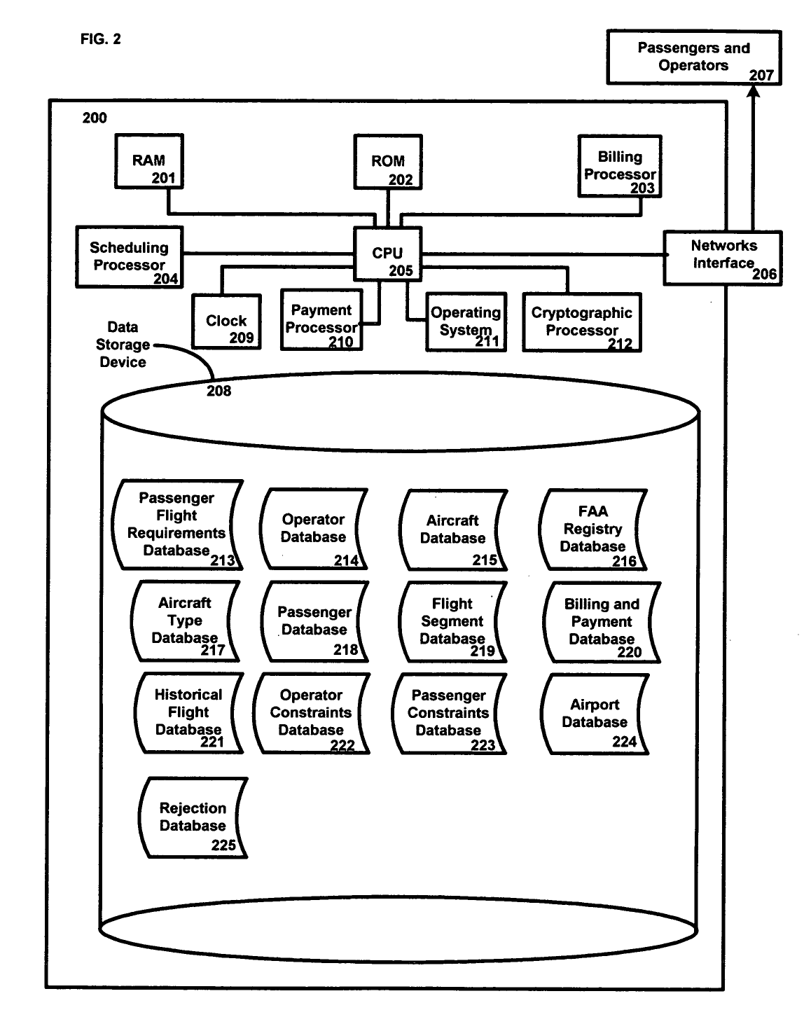

As shown in FIG. 2, a central controller 200 includes central processor (CPU) 205, random access memory (RAM) 201, read only memory (ROM) 202, clock 209, operating system 211, network interface 206, and data storage device 208. A conventional personal computer or computer server with sufficient memory and processing capability may be used as the central controller 200. In one embodiment it operates as a web server, both receiving and transmitting data inquiries generated by end users. The central controller 200 must be capable of high volume transaction processing, performing a significant number of mathematical calculations in processing communications and database searches. A Xeon Pentium microprocessor, commonly manufactured by Intel Inc., may be used for the CPU 205. This processor employs a 32-bit architecture. Equivalent processors include the IBM PowerPC or Sun Microsystem's UltraSPARC.

A Sun Crypto Accelerator 4000 Board, commonly manufactured by Sun Microsystems Inc., may be used for cryptographic processor 212. Equivalent processors may also be used. The PCI-based coprocessor board is designed to off-load IPsec and SSL cryptographic functions from the main system processor 205. The card accelerates SSL session establishment processes to up to 4300 operations per second, and accelerates 3DES bulk data encryption to up to 10 times faster than on a system without hardware acceleration. Cryptographic processor 212 supports the authentication of communications from both the operators and passengers, as well as allowing for anonymous transactions. Cryptographic processor 212 may also be configured as part of the CPU 205.

Referring again to FIG. 2, a billing processor 203, a scheduling processor 204, and a payment processor 210 comprise conventional microprocessors (such as the Intel Xeon Pentium), supporting scheduling, the transfer and exchange of payments, charges, or debits, attendant to the method of the apparatus. Any one or all of the processors 203, 204, 210 may also be configured as part of the CPU 205. Processing of credit card transactions by these processors 203, 210 may be supported with commercially available software, such as the Monetra manufactured by Main Street Softworks, Inc. This server software transmits credit card numbers electronically over the Internet to servers located at a credit card clearing company, such as CardService International, where card verification and processing is handled.

Data storage device 208 may include hard disk magnetic or optical storage units, as well as CD-ROM drives, DVD or flash memory. The data storage device 208 contains a number of different databases used in the processing of transactions in the present invention, including Passenger Flight Requirements Database 213, Operator Database 214, Aircraft Database 215, FAA Registry Database 216, Aircraft Type Database 217, Passenger Database 218, Flight Segment Database 219, Billing And Payment Database 220, Historical Flight Database 221, Operator Constraints Database 222, Passenger Constraints Database 223, Airport Database 224, and Rejection Database 225.

In a preferred embodiment, database software such as Oracle10, manufactured by Oracle Corporation, is used to create and manage these databases. Alternatives would be DB2 from IBM Corporation, SQL Server from Microsoft or MySQL Database by MySQL AB.

The Passenger Flight Requirements Database 213 maintains data on the flight requests by passengers including passenger number, origination address, destination address, origination date and time, destination date and time, variances allowed for the flight, and intermediate stops allowed.

The FAA Registry Database 216 is the listing of all general aviation aircraft registered with the FAA. This database includes aircraft registration number (N number), aircraft model number, aircraft age, owner, owner address, operator name and address.

The Flight Segment Database 219 maintains data on all flight segments including passenger number, origination address, destination address, origination date and time, destination date and time, flight distance and computed time to complete flight.

The Operator Constraints Database 222 maintains data on how operators will deliver charter service including hours of operation, re-position flight distance limits, wait time limits, overnight rules, region serviced and revenue per flight hour by aircraft.

The Operator Database 214 maintains data on the operators, including name, address, phone number, fax number, email addresses, payment preferences, rates, availability standards, voice mail addresses, aircraft fleet and service areas.

The Aircraft Type Database 217 maintains data on all aircraft types certified for use by the FAA for use in air charter operations including aircraft model number, year of manufacture, gross weight, empty weight, useful load, fuel capacity, number of engines, type of engines, climb speed, climb rate, cruise speed, fuel consumption for all phases of flight, passenger seats, crew required, and take off and landing limitations.

The Billing and Payment Database 220 tracks all commercial transactions, as well as payment and billing preferences. This database is valuable in the event of complaints by both passengers and operators regarding payment, because an audit trail can be produced.

The Passenger Constraints Database 223 maintains information on passengers including weight, ground transportation requirements and preferences for number of stops, earliest departure time, latest arrival time, meals and refreshments, and aircraft type.

The Aircraft Database 215 maintains information on aircraft used by operators for charter service. This database is cross-referenced with the FAA Registry Database and the Aircraft Type Database.

The Passenger Database 218 maintains information on passengers registered with the service including home address, phone number, fax number, email address, pager number, emergency contact, and preferred payment method.

The Historical Flight Database 221 archives information on all completed flights, de-normalized for data warehouse and analytical use.

The Airport Database 224 maintains information on all public use airports, and private use airports with landing permission, used by charter operators including latitude and longitude, address, city, fixed base operators on the airport, runway data, instrument landing approach data, services available e.g. rental cars, restaurants, hotels.

The Rejection Database 225 maintains information on all rejection reasons, possible solutions and occurrences of rejections. This is for both passengers and operators.

The network interface 206 is the gateway to communicate with passengers and operators through respective passenger interface and operator interface 207. The network interface 206 supports modems at a range of baud rates from 19.2K upward, but may combine such inputs into a T1 or T3 line if more bandwidth is required. In a preferred embodiment, the network interface 206 is connected with the Internet or any of the commercial online services such as America Online, CompuServe, or MSN, allowing passengers access from a wide range of online connections. Alternatively, the network interface 206 may be configured to a voice response interface, web site, wireless device interface or email service.

While the above embodiment describes a single computer acting as the central controller 200, another embodiment is illustrated in FIG. 3 that shows the central controller 305 and associated database 306 attached to the public switched network 304, like the Internet. Operators connect to the system through the Operator interface 301 and passengers connect to the system through the passenger interface 303. All nodes connect to the network 304 through a network connection that involves a modem or equivalent device 302.

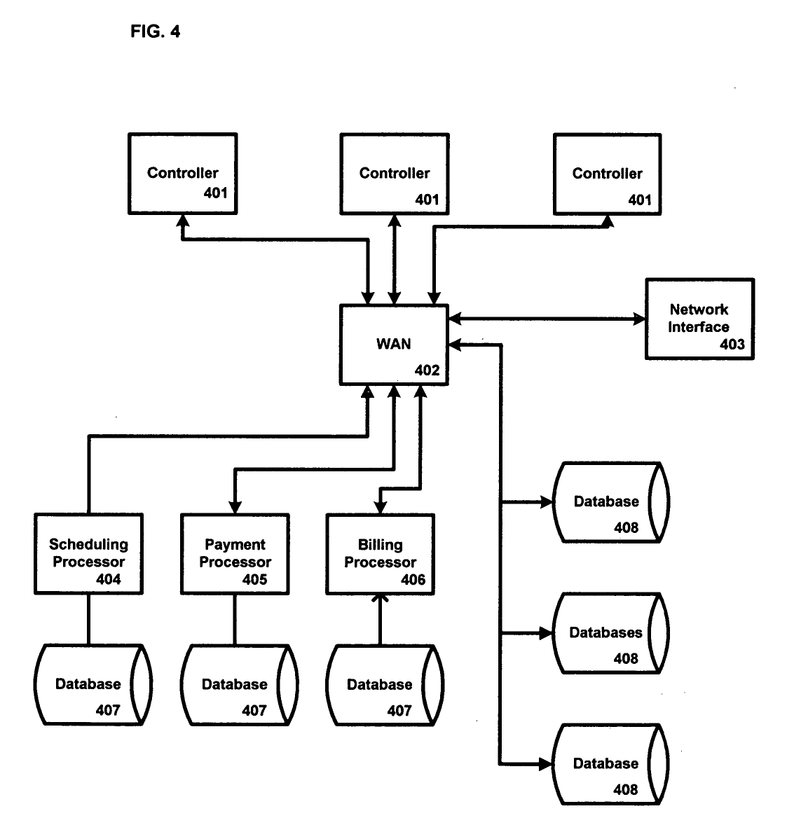

Functionality can be distributed over a plurality of computers. In another embodiment, the central controller 200 may be configured in a distributed architecture, as shown in FIG. 4, wherein the databases and processors are housed in separate units or locations. Controllers 401 perform the primary processing functions and contain, at a minimum, RAM, ROM, and a general processor. Each of these controllers 401 is attached to wide area network (WAN) hub 402 which serves as the primary communication link with the other devices. The WAN hub 402 may have minimal processing capability itself, serving primarily as a communications router. Although only three controllers are shown in this embodiment, an almost unlimited number of controllers may be supported. In such a configuration, each controller is in communication with its constituent parts, but the processor and data storage functions are performed by stand-alone units. A payment processor 405 and associated database 407, a billing processor 406 and associated database 407, a scheduling processor 404 and associated database 407, and operator and passenger databases 408 all communicate through the WAN hub 402 with the controllers 401. This arrangement yields a more dynamic and flexible system, less prone to catastrophic hardware failures affecting the entire system. The network interface 403 is the gateway to communicate with passengers and operators through respective passenger interface and operator interface (not shown). The network interface 403 supports modems at a range of baud rates from 19.2K upward, but may combine such inputs into a T1 or T3 line if more bandwidth is required. In a preferred embodiment, the network interface 403 is connected with the Internet or any of the commercial online services such as America Online, CompuServe, or MSN, allowing passengers access from a wide range of online connections. Alternatively, the network interface 403 may be configured to a voice response interface, web site, wireless device interface or email service.

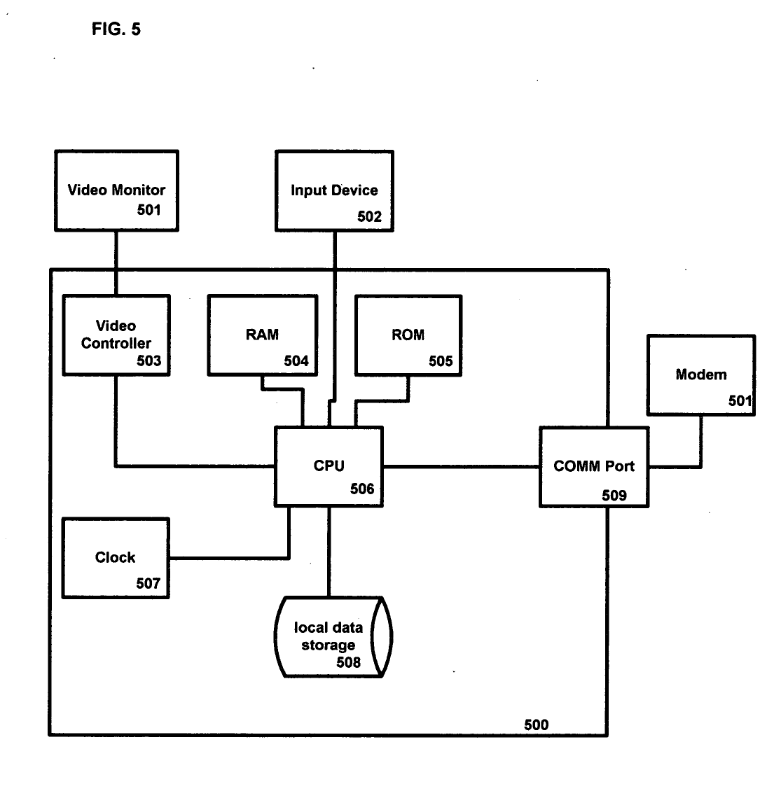

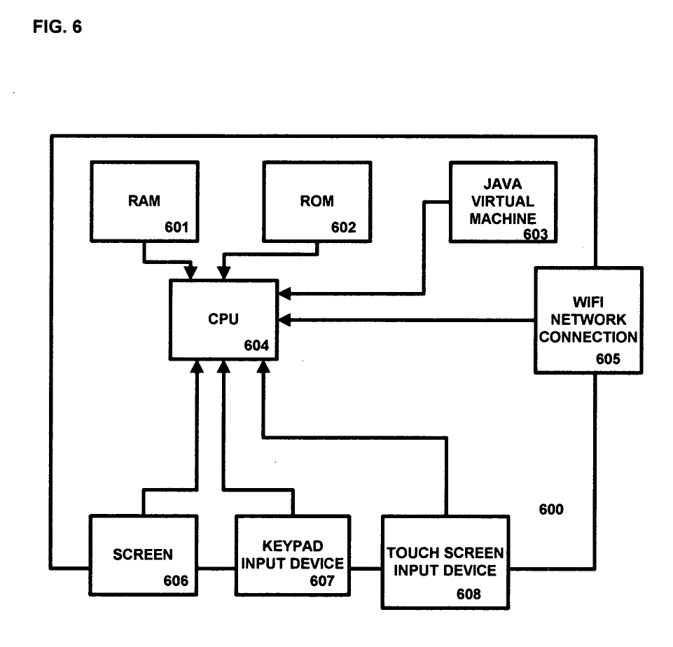

FIG. 5 illustrates operator interface and passenger interface 500. In an exemplary embodiment, the operator interface and passenger interface 500 are both conventional personal computers having an input device, such as a keyboard, mouse, or conventional voice recognition software package; a display device, such as a video monitor; a processing device such as a CPU; and a network interface such as a modem. Alternatively, the operator interface and passenger interface 500 may also be voice response systems, electronic or voice communications systems, JAVA enabled cell phones and wireless personal digital assistants (PDAs) (see FIG. 6). The interface 500 includes a central processor unit (CPU) 506, RAM 504, ROM 505, clock 507, video controller 503, video monitor 501, communication port 509, input device 502, modem 509, and data storage device 508.

A Pentium microprocessor or PowerPC, used in Apple Macintosh computers, may be used for the CPU 506. The clock 507 is a standard chip-based clock which can serve to time-stamp responses produced by the interface 500. The modem 509 may include asynchronous communications, DSL, cable modem and other methods for data communications. The data storage device 508 is a conventional magnetic based hard disk storage unit, such as those manufactured by Seagate.

FIG. 6 illustrates an alternative operator interface and passenger interface in the form of a PDA 600. In an exemplary embodiment, the PDA includes an input device, such as a keypad 607, touch screen 608 or conventional voice recognition software package; a display device, such as a screen 606, a processing device such as a CPU 604; and a network interface such as a WIFI network connection 605. The interface 600 includes the CPU 604, RAM 601, ROM 602, and Java virtual machine 603.

### Asynchronous Communications Embodiment

In one embodiment of the present invention, communications between passengers and operators takes place asynchronously. The end user creates a Customer Transportation Request 700 (FIG. 1A) and transmits it to the central controller 200 (FIG. 2). The request 700 can be entered through the operator interface and passenger interfaces 500 which can be in the form of a variety of devices including Personal Computers (FIG. 5), Personal Digital Assistants 600 (FIG. 6), through a voice response interface to the central controller 200 (FIG. 2). The system computes a unique customer score 1200 (FIG. 1A). The system uses the score 1200 to determine if an existing flight exists or an alternative flight can be used 1300 (FIG. 1) or if a new flight is required 1400 (FIG. 1A). The system then calculates the fare for the passenger 1500 (FIG. 1A). The system transmits the fare and flight information to the passenger for acceptance 1000 (FIG. 1). If accepted, the system transmits the flight information to the operator for acceptance 1800 (FIG. 1). If accepted by the operator 104 (FIG. 1), the system completes the booking of the flight. This embodiment of the invention completes the entire process without direct communication between the passenger and operator.

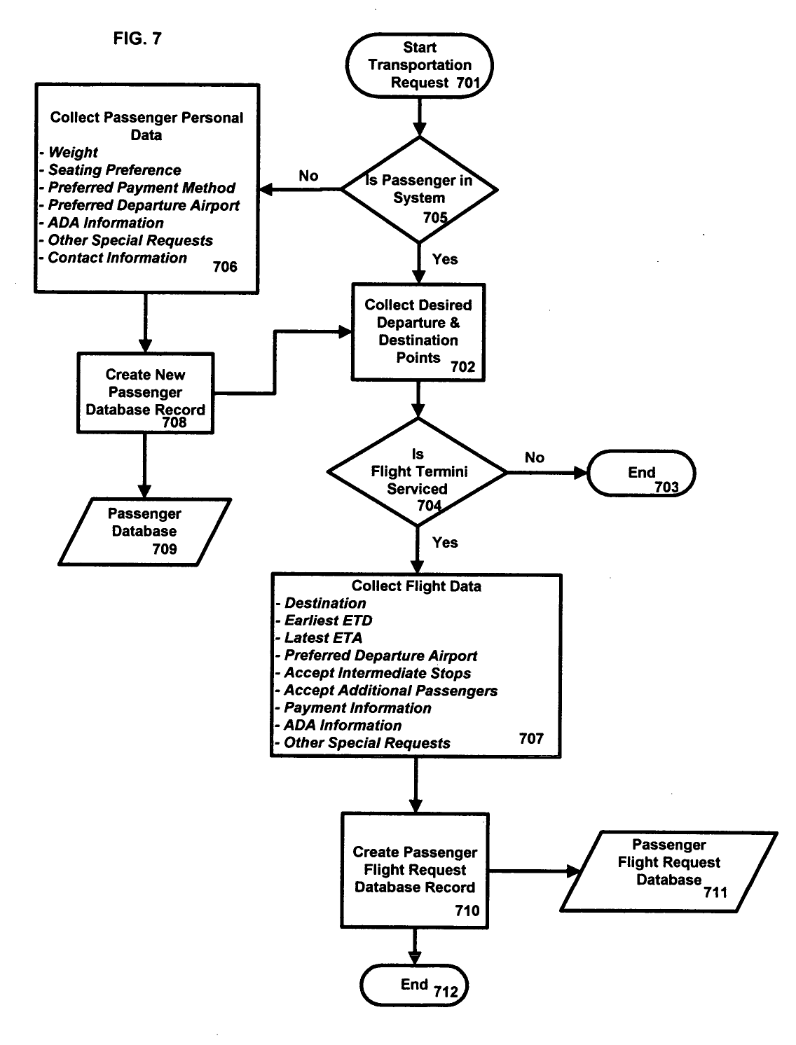

As seen in FIGS. 1 and 7, the system waits for a passenger request to be entered in the Customer Transportation Request Process 700. The transportation request starts 701 with the passenger logging in as an old user or registers as a new user 705. If the user is new, the registration process collects 706 all information necessary to create a new passenger record 708 in the Passenger Database 709. This information collected includes, but is not limited to, weight, seating preference, preferred payment method, preferred departure airport, ADA information, special requests, contact information and the like. Once logged in, the passenger's travel origination point and destination point are collected 702. If either of the points are not serviced 704 by any of the operators registered with the system, the process ends with passenger notification that a flight cannot be met 703. If the travel points are serviced 704, the system collects data about the flight 707 (i.e., destination, earliest estimated time of departure, latest estimated time of arrival, preferred departure airport, intermediate stops, whether additional passengers are accepted, payment information, ADA information, special requests and the like), creates a passenger flight request database record 710, and updates the Passenger Flight Request Database 711 before ending 712.

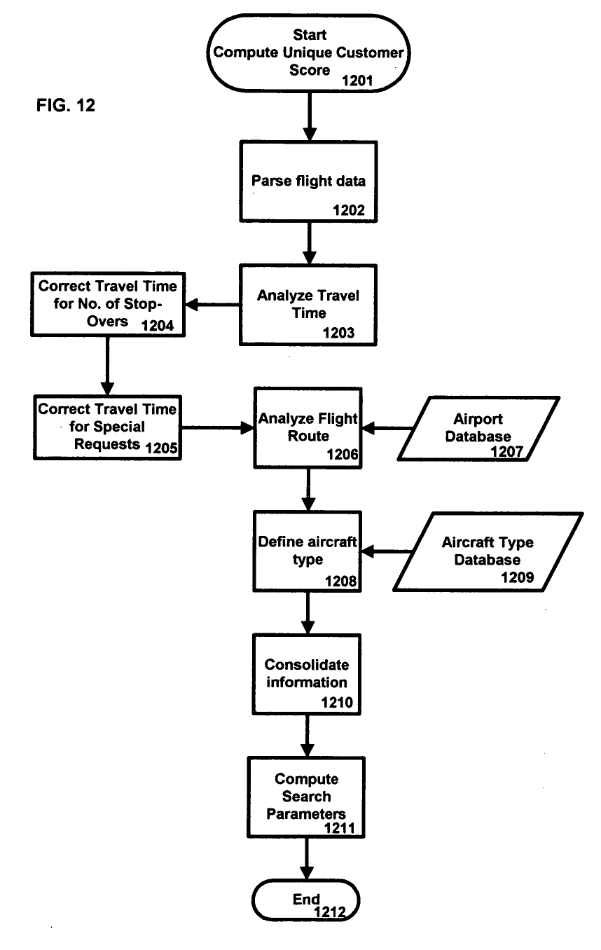

Once a Passenger Flight Request is received, it is passed to the Compute Unique Customer Score process 1200, as illustrated in FIGS. 1A and 12. The computation of the unique customer score starts 1201 with the flight information or data being converted into longitude and latitude data requested total travel time 1202. The travel time is then analyzed and computed 1203 with any variables such as stop-overs 1204, required departure times, required arrival times and special requests 1205. The route of flight is analyzed for other departure and arrival locations that may meet the requirements of the passenger 1206, based partly on information in the airport database 1207. The results of the previous computations are used to define a minimum aircraft type (e.g., twin engine turboprop with cruise speed of at least 270 knots per hour) 1208, based partly on information in the aircraft type database 1209. The various data computed and looked up is combined into a single data set 1210. This data set is then processed by the search algorithm to build a comprehensive search function to identify any potential flight to meet the passenger's request 1211 before the process ends 1212.

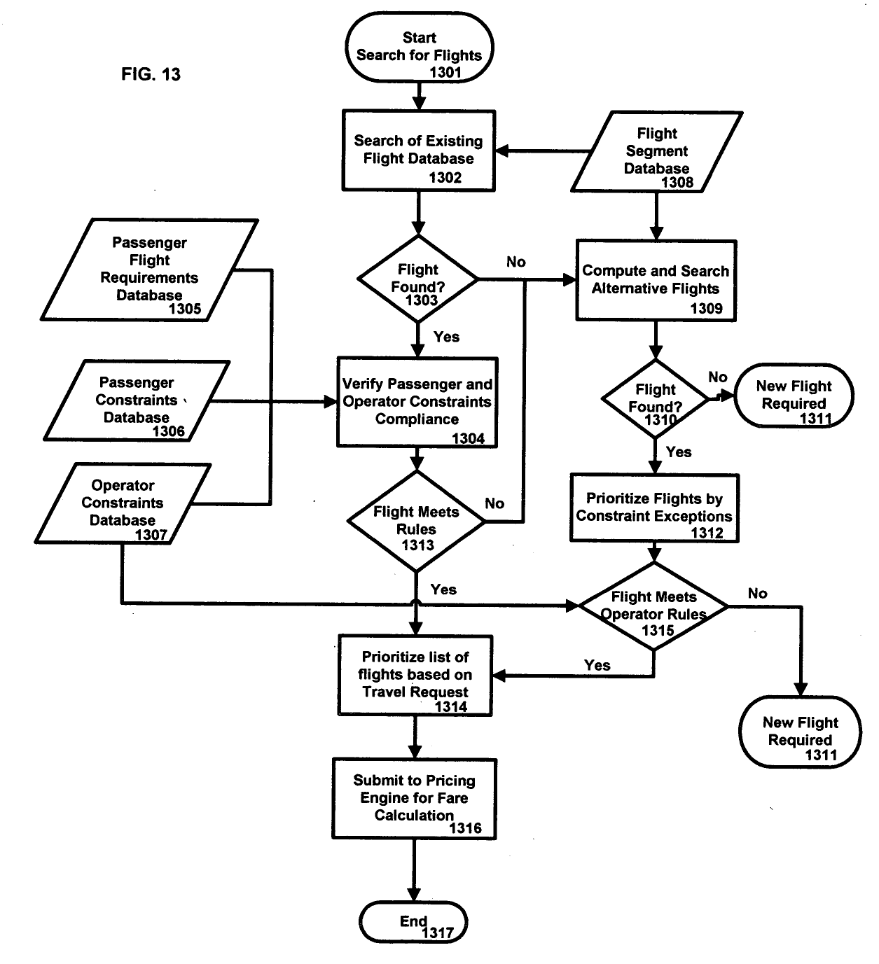

The search function then performs a search for a flight(s) that meet the passenger's request 1300, as detailed in FIGS. 1A and 13. The process starts 1301 with a search for an exact match to an existing flight 1302, based on information in the flight segment database 1308. If found 1303, the operator and passenger constraints are verified for compliance 1304 against the Passenger Flight Request Database 1305, Passenger Constraints Database 1306, and Operator Constraints Database 1307. If the flight(s) is in compliance with all constraints 1313, the list is prioritized based on the original request 1314, and the results are sent to the Pricing Process for fare calculation 1316. If an existing flight is not found 1303, alternative flights parameters are computed 1309 and searched for 1310. If an alternative is found, the flights are categorized by exceptions to the travel request 1312. Operator constraints are tested for compliance 1315. If compliant, the flights are prioritized 1314 and submitted to the price process or pricing engine for fare calculation 1316 before the process ends 1317. If an alternative flight cannot be found 1310, the process ends by calling the New Flight Required Process 1311. If the flight does not pass the Operator Compliance test, the process ends by calling the New Flight Required Process 1311.

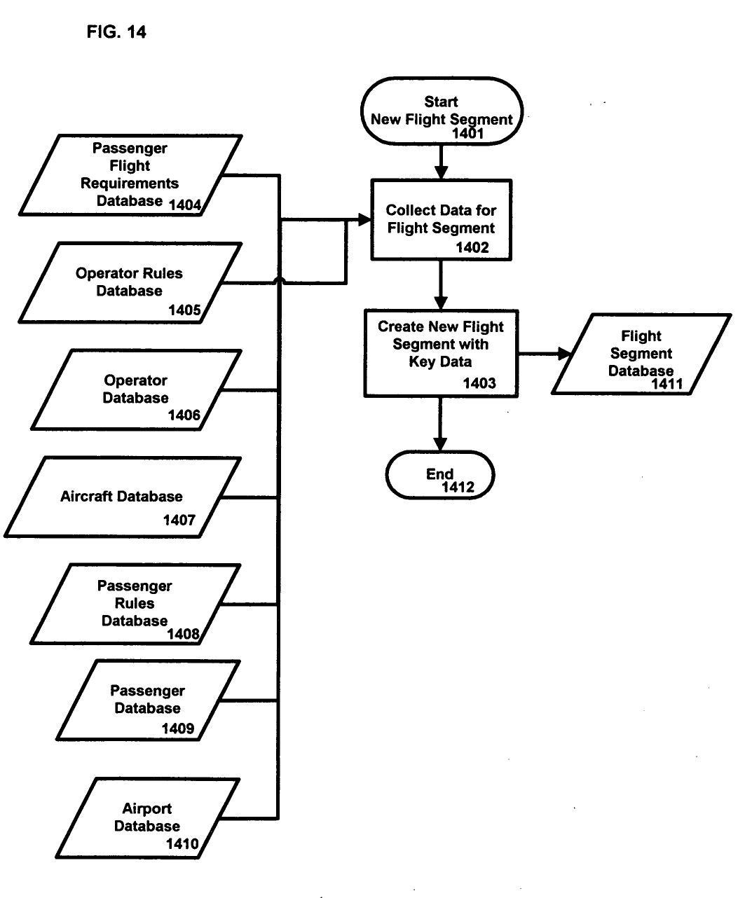

If an existing flight or alternative does not exist 1300, the New Flight Required Process 1400 is called up, as detailed in FIGS. 1A and 14. This process 1400 is a database program that combines key data from other databases and creates a new record in the Flight Segment Database 1411. The new flight process starts 1401 with the collection of data for the flight segment 1402 with information coming from, respectively, the passenger flight requirements, operator rules, operator, aircraft, passenger rules, passenger and airport databases 1404, 1405, 1406, 1407, 1408, 1409, 1410. The new flight segment is created 1403 with key data placed into the flight segment database 1411 before the process ends 1412.

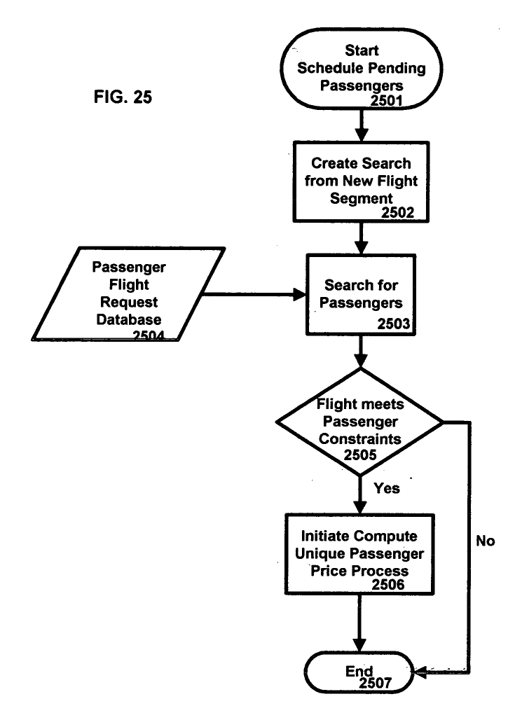

In the case of a new flight being created 1400, the system then searches for any pending passenger requests that may be met with the new flight segment 2500, as illustrated in FIGS. 1A and 25. The process of scheduling pending passengers starts 2501 with a search function being computed from the new flight segment 2502, and a search performed 2503 against the Passenger Flight Request Database 2504 for any open requests that have not been met. If a match is found, passenger constraints are tested for compliance 2505 and the process ends 2507. If compliant, the data is passed to the Pricing Process 2506 and the process ends 2507.

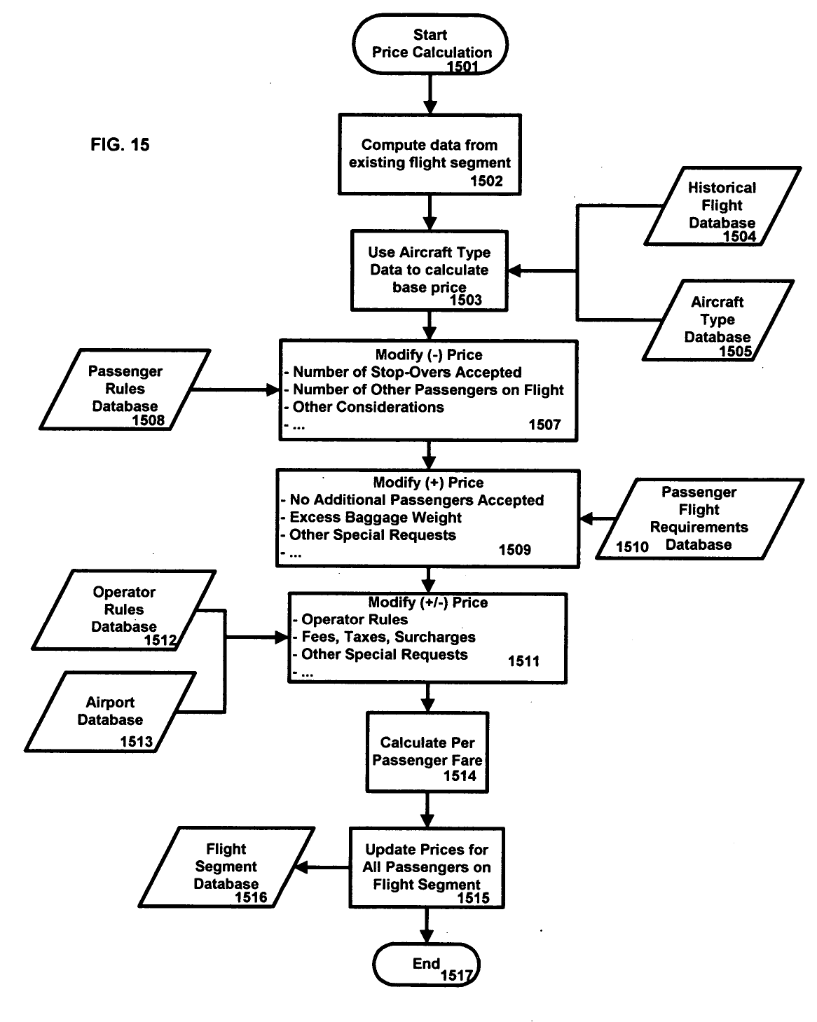

FIGS. 1A and 15 illustrate the price method as a key component of the present invention in the computation of fares. The Compute Unique Passenger Price Process 1500 accumulates all data about the flight in order to compute a price that is both profitable for the charter operator and competitive with alternative travel options for the passenger. The process starts 1501 with information about the flight segment being computed for time, travel speed, required stop-overs, origination of the aircraft, final destination of the aircraft after the flight segment destination and special requirements 1502. The base price for the flight segment is computed 1503 using data from the Historical Flight Database 1504 and Aircraft Type Database 1505. The passenger rules database 1508 provides information for several price modification calculations to be performed that decrease the price 1507, increase the price 1509, based partly on information from the passenger flight requirements database 1510, or perform a combination 1511 based on input from the operator rules and airport databases 1512, 1513. Examples of what modifications address are increased stop-overs allowed by passengers 1507, number of other passengers on the flight 1507, excess baggage requirement 1509 and consideration for taxes, fees, operator constraints 1511. Once this is done, the system calculates the per passenger fare, starting with parity for each passenger and then adjusting for specific passenger constraints 1514. Prices are updated for all passengers on the flight segment 1515 and the price information is then updated in the Flight Segment Database 1516 before the price calculation process stops 1517.

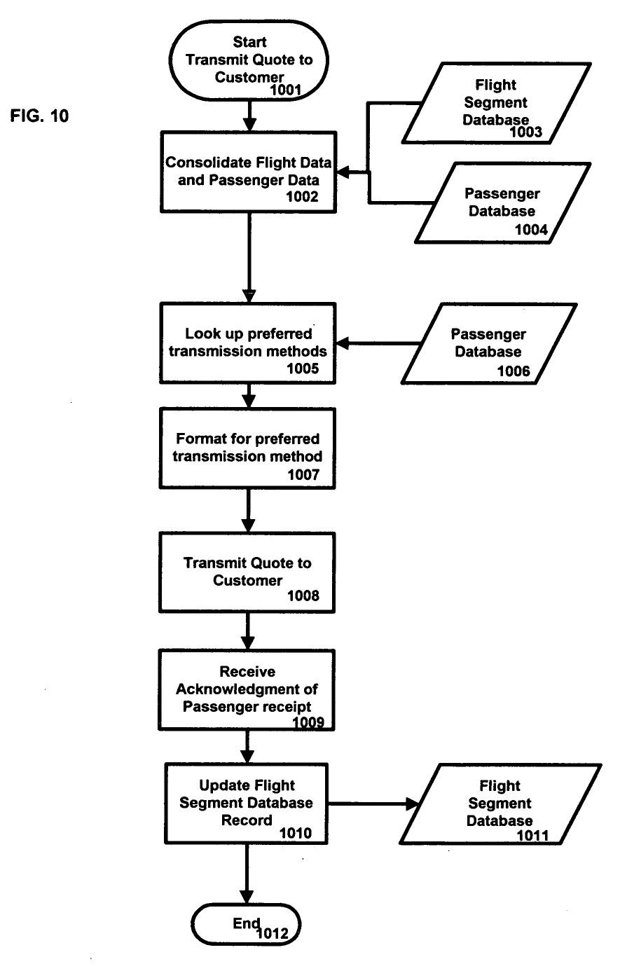

As shown in FIGS. 1A and 10, the basic flight data and fare information can be transmitted to the passenger 1000 at this point in the process. The process of transmitting the quote to the customer starts 1001 with looking up and consolidating all necessary data to transmit to the passenger 1002 from information contained in the flight segment and passenger databases 1003, 1004. The preferred transmission method (e.g., Email, fax, voice response, etc.) is determined 1005 from the Passenger Database 1006 and the data is formatted based on the transmission method 1007. The Fare Quote is then transmitted to the customer 1008 and the system records receipt acknowledgment, if available, to confirm delivery of the fare quote 1009. The Flight Segment Database 1011 is then updated to indicate that the flight segment is in pending status 1010 before the process ends 1012.

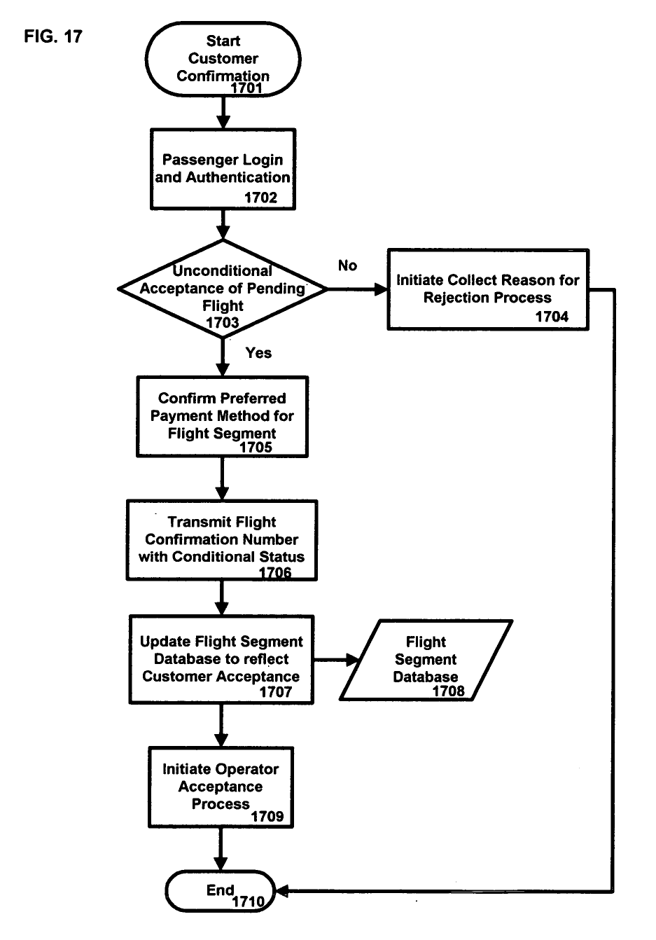

The next step required to complete the transportation request is to receive confirmation from the passenger that the flight is acceptable 1700, as seen in FIGS. 1B and 17. Based on a passenger receiving a fare quote 1000 (FIG. 1A), the passenger starts the confirmation process 1701 by logging into the system and being authenticated 1702. The passenger is able to review the flight(s), including details and exceptions to the original transportation request. The passenger then has the option to accept the flight as it is listed or reject it 1703. If the flight is accepted, the passenger is asked to confirm their payment method for this particular flight 1705. The passenger receives a confirmation number for the flight indicating it is pending final booking 1706. The Flight Segment Database 1708 is updated to reflect this change in status to the flight segment 1707. This process ends 1710 by initiating the Operator Acceptance Process 1709. If the passenger rejects the flight, the Collect Reason for Rejection Process 900 is called 1704 and the process ends 1710.

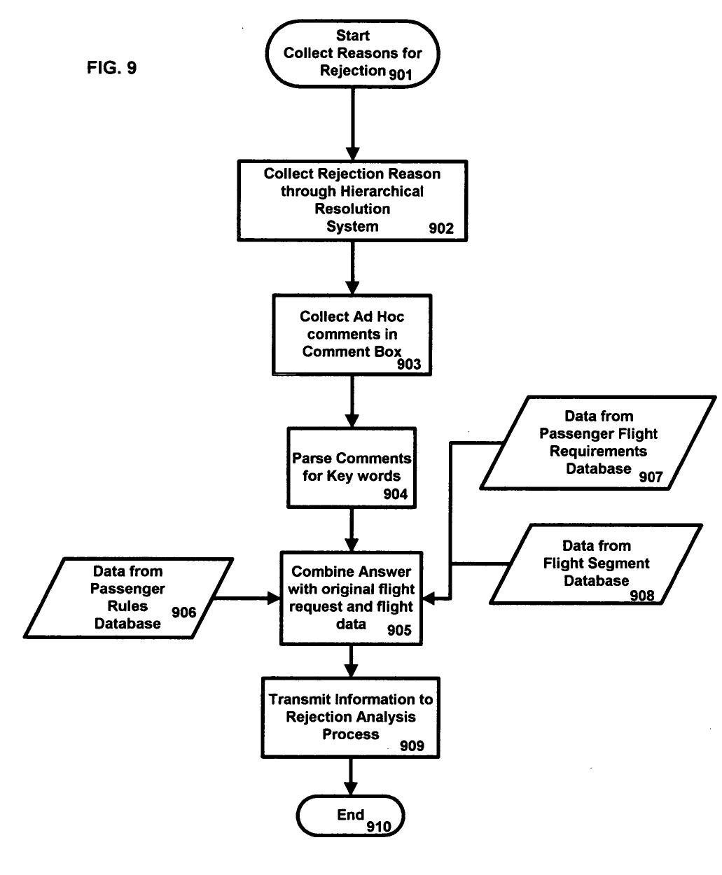

As seen in FIGS. 1B and 9, the Collect Reason for Rejection Process 900 starts 901 by collecting the rejection reason through a hierarchical resolution system 902. Ad hoc comments are collected in a collection box 903 and the comments are parsed for key words 904. The answer is combined with the original flight request and flight data 905 with data coming from the passenger flight requirements database 907, flight segment database 908 and the passenger rules database 906. The process ends 910 after information is transmitted to a rejection analysis process 909, 1900.

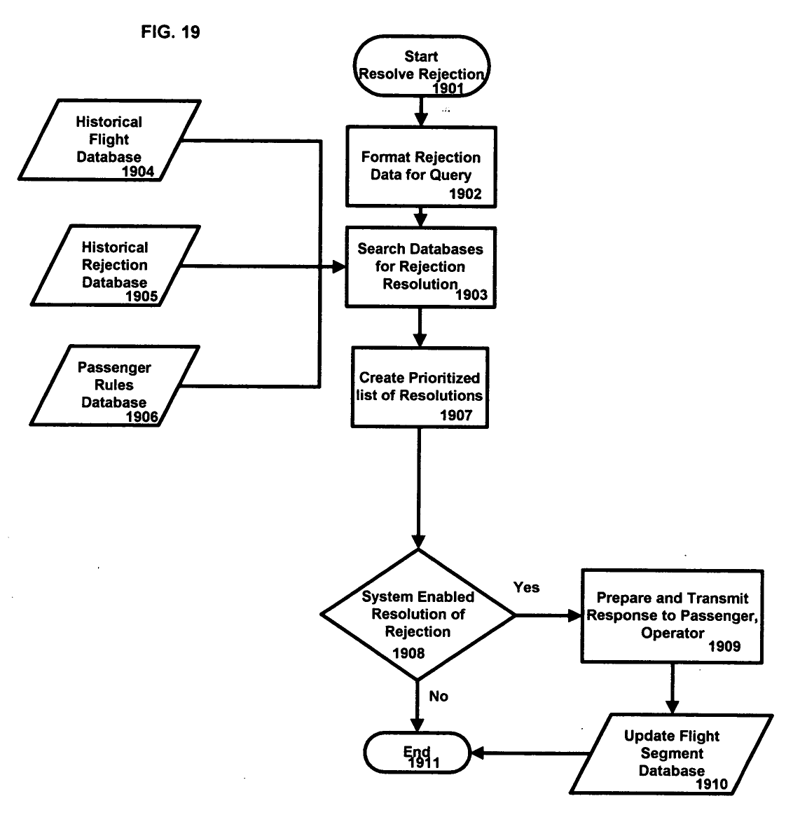

As seen in FIGS. 1B and 19, the rejection analysis process 909, 1900 starts 1901 by formatting the rejection data for query 1902. The historical flight 1904, historical rejection 1905 and passenger rules 1906 databases are searched for a rejection resolution 1903 and a prioritized list of resolutions is created 1907. If there is no system enabled resolution of the rejection 1908, then the rejection analysis ends 1911, but if there is, then a response is prepared and transmitted to the passenger and operator 1909 and the flight segment database updated 1910 before the analysis ends 1911.

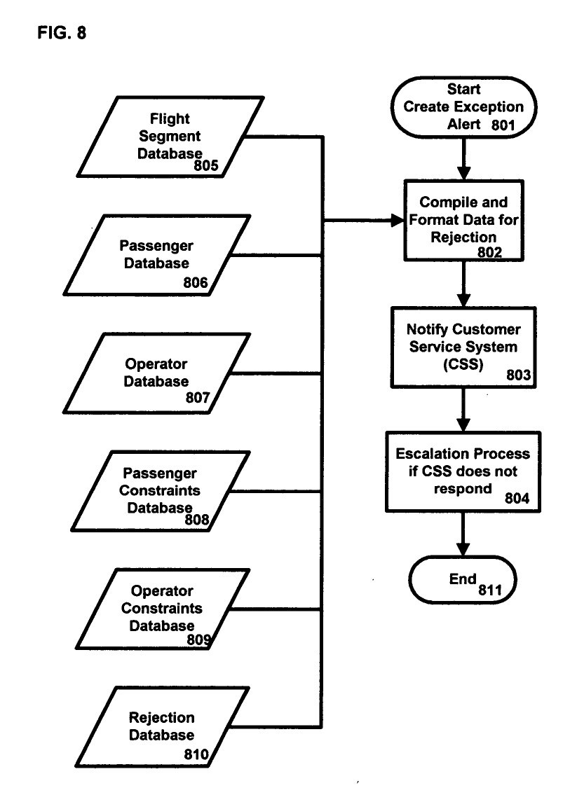

If the rejection is not resolved 103, then an exception alert is created 800, as seen in FIGS. 1B and 8, that starts 801 with the compilation and formatting of data for the rejection 802. The compilation and formatting 802 is based upon the data in several databases including, respectively, the flight segment, passenger, operator, passenger constraints, operator constraints and rejection databases 805, 806, 807, 808, 809, 810. The customer service system (CSS) is notified 803 and the process ends 108, 811 with an escalation process commenced if the CSS does not respond 804.

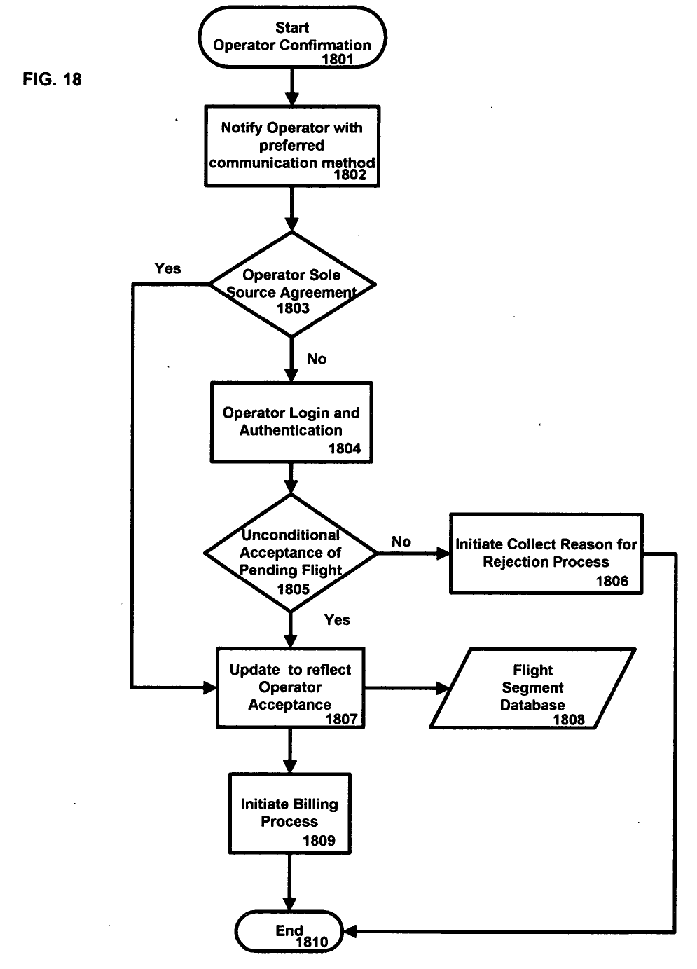

Once a flight segment is accepted by the passenger, the operator delivering the service needs to also accept the flight 1800. FIGS. 1B and 18 illustrate that the operator confirmation process starts 1801 with first notifying the operator with a preferred communication method 1802. One embodiment of this step includes an automatic escalation process that uses alternative communication methods if a response is not received in a timely manner. If the operator has in place a “sole source” agreement that binds all of their charter service to the system 1803, the process updates 1807, the Flight Segment Database 1808, with operator acceptance and the Billing Process is initiated 1809 before the process ends 1810. If the operator is not under a “sole source” agreement, the operator logs in to the system and authenticated 1804. Upon review the operator can accept the flight unconditionally 1805 or reject it. If accepted, the process completes the update and billing processes, 1807 and 1809 respectively. However, if rejected, the Collect Reasons For Rejection Process is initiated 1806 before the process ends 1810.

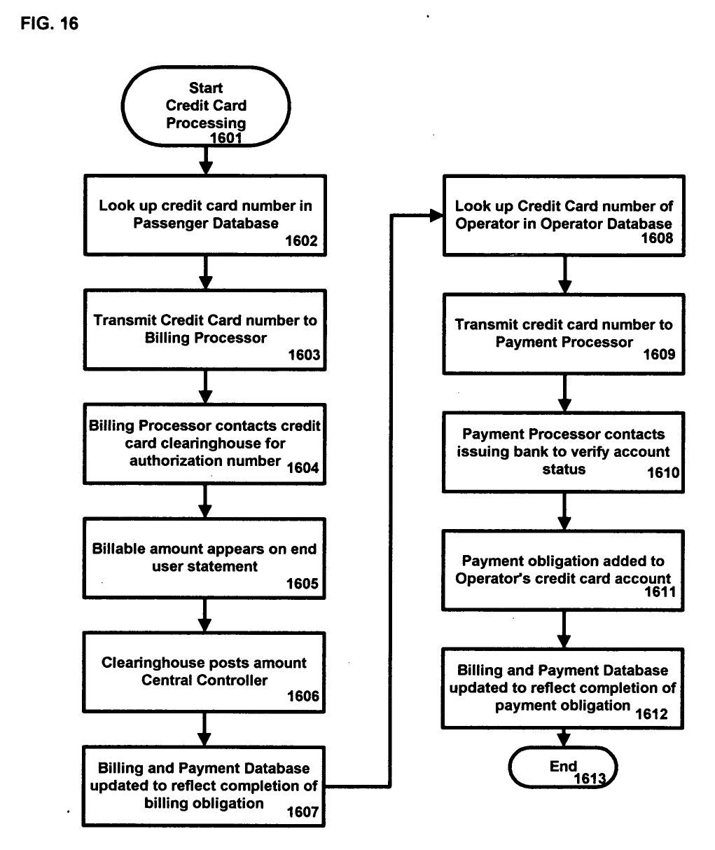

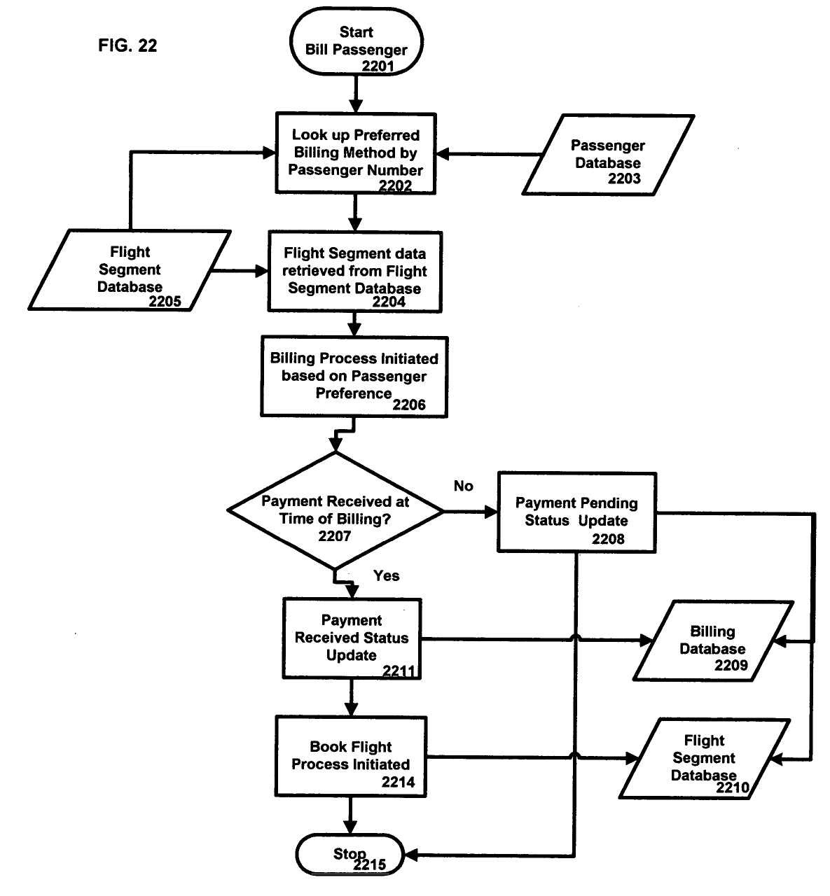

If a flight segment has received both passenger and operator acceptance, the Bill Passenger Process 2200 is the initiated next, as seen in FIGS. 1C and 22. The passenger billing starts 2201 with looking up the preferred billing method for that passenger and for the specific flight segment 2202, based upon information contained in the passenger database 2203. This step allows passenger's to have multiple bill methods on file and decide by individual flight how to pay for them. Billing information for the flight segment is retrieved 2204 from the Flight Segment Database 2205. The preferred billing process is initiated 2206. This can include credit card payment, as shown in FIG. 16, electronic funds transfers, debit card transactions, payment with PayPal, and bank wire. If the payment is received at time of billing 2207, as would be the case in a credit card or debit card transaction, the Billing Database 2209 and Flight Segment Database 2210 would be updated to show this status 2211. The Book Flight Process is then initiated 2214 and the billing process stops 2215. If payment is not received at time of billing 2207, a pending status 2208 is set in the Billing Database 2209 and Flight Segment Database 2210 and the billing process stops 2215. This now becomes an account receivable item to track.

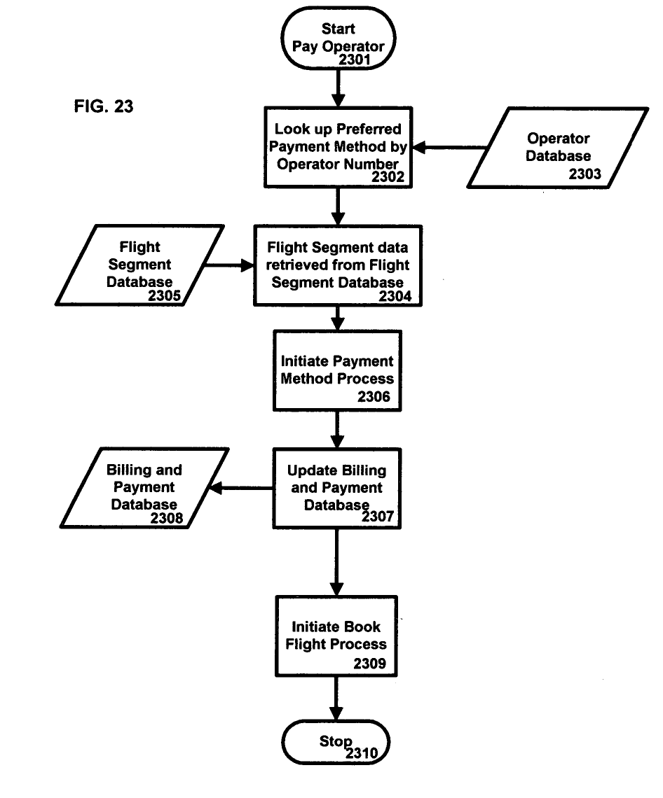

Once payment is received from the passenger, the Pay Operator 2300 process, shown in FIGS. 1C and 23, is initiated 2301. The preferred payment method is looked up 2302 from the Operator Database 2303. Price information is retrieved 2304 from the Flight Segment Database 2305. The payment method is initiated to transmit the payment to the operator 2306. The status is then updated 2307 in the Billing and Payment Database 2308. The Book Flight Process is then called 2309 and the pay operator process stops 2310.

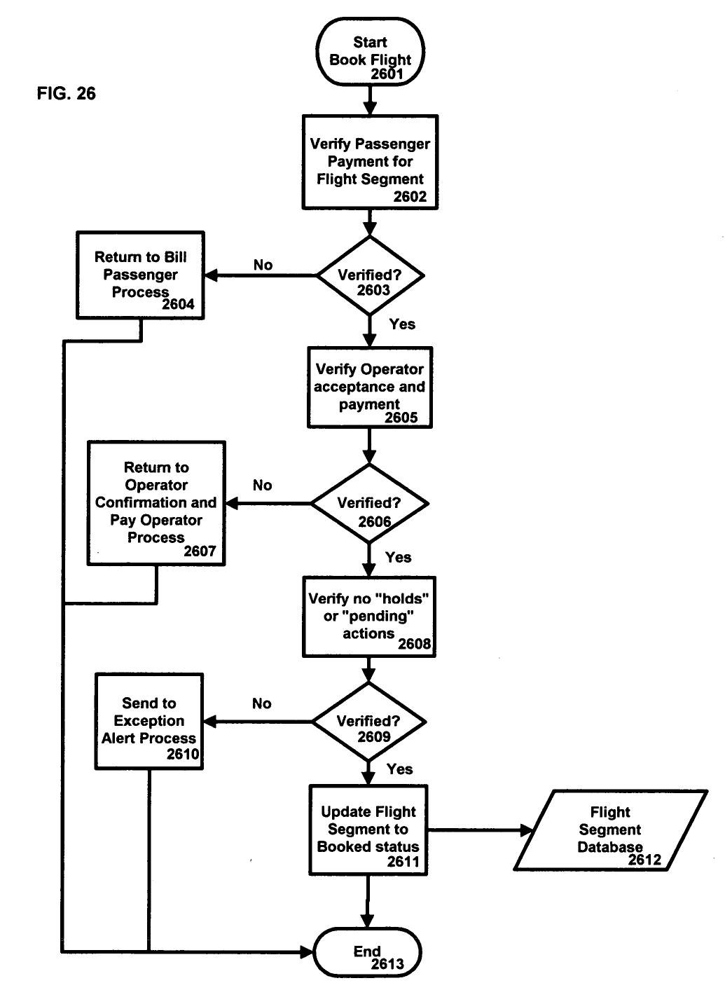

The Book Flight Process 2600 (FIG. 1C), is the final confirmation step to commit a passenger and operator to a flight. Charter flights cannot be canceled without a penalty assessment to the party canceling the flight. All parties wishing to enter a binding commitment to the flight follow the process illustrated in FIG. 26. The process starts 2601 with passenger payment being verified as having been received without holds or conditions 2602 and 2603. If not true the book flight process calls the Bill Passenger Process 2604 and ends 2613. Operator acceptance is received and the operator is paid 2605 and 2606. If not true the Operator Confirmation and Pay Operator Processes are called 2607 and the book flight process ends 2613. No “holds” or incomplete actions is confirmed 2608 and 2609. If not true, an exception alert is generated 2610 and the book flight process ends 2613. If all tests are true, the Flight Segment Database 2612 is updated to reflect that the flight is booked and both parties are bound 2611.

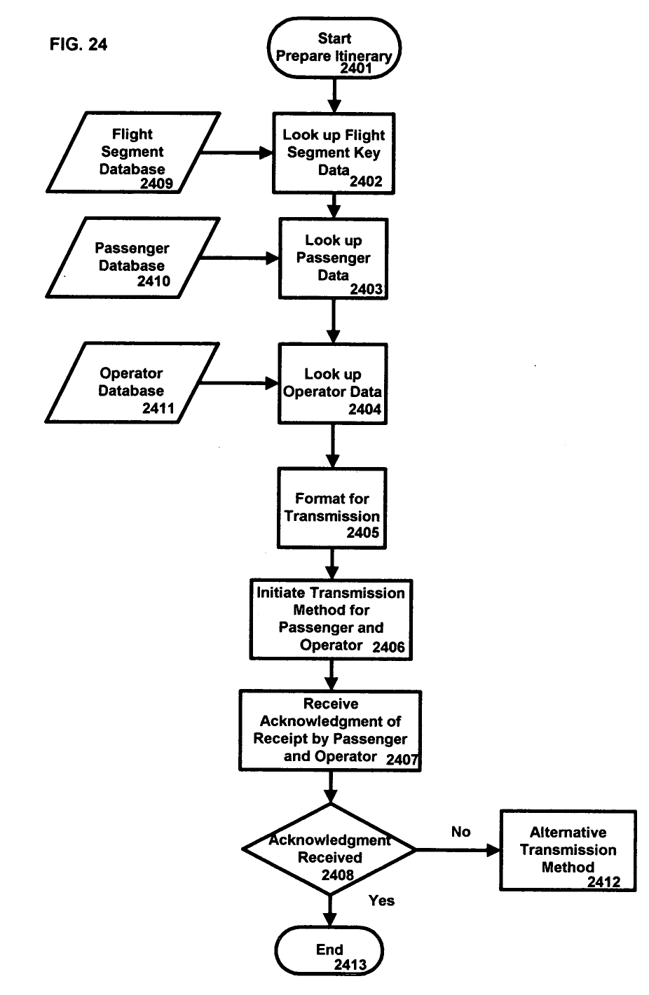

The final step for passenger and operator is to generate the detailed itinerary for the passenger and flight plan for the operator 2400 2400, as detailed in FIGS. 1C and 24. The process starts with the preparation of an itinerary 2401 by looking up all required data from the Flight Segment Database 2402, 2409, Passenger database 2403, 2410, and Operator data 2404 from the operator database 2411. The information is combined and formatted for the transmission methods requested by the passenger and operator 2405. The preferred transmission method is used to send the information to passenger and operator 2406, receive acknowledgment of receipt 2407 and escalate if confirmation of delivery is not received 2408 and 2412. If acknowledgment is received, the step ends 2413.

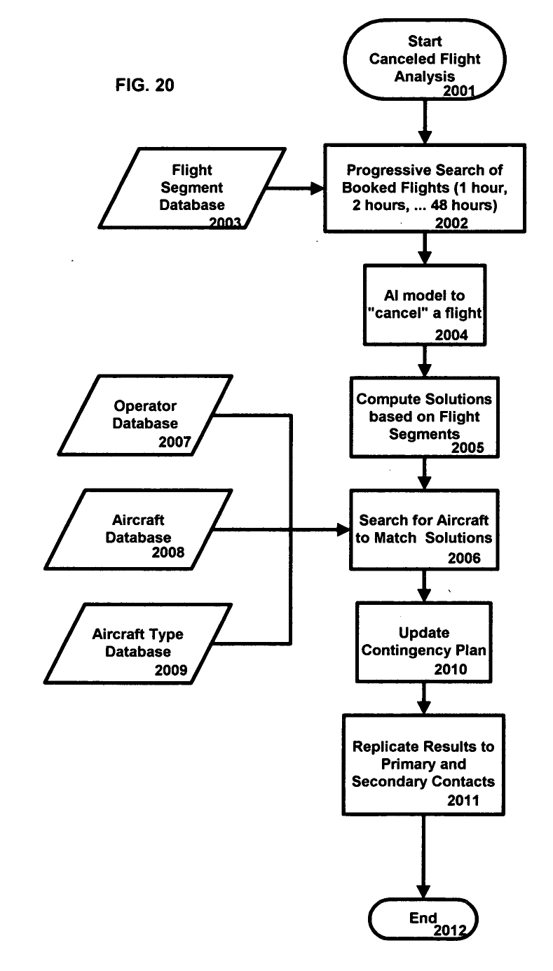

The final step is for the system to initiate a proactive planning process that calculates all possible scenarios to resolve a canceled flight situation and prepares the most optimal model 2000, as illustrated in FIGS. 1C and 20. The system searches flights in the future progressively. The canceled flight analysis starts 2001 with a search of flights one hour in the future, then two hours and so forth 2002, based on information in the flight segment database 2003. An artificial intelligence algorithm applies different selection routines to cancel flights 2004 and then search for possible solutions to the canceled flight 2005. This algorithm may use the Monte Carlo formula to select flights in a random fashion. Once an optimal solution set is generated, the system then searches for aircraft to fulfill the solution if required 2006, based upon information in the operator, aircraft, and aircraft type databases 2007, 2008, 2009. A dynamic contingency plan is then updated to reflect the latest flight segment data 2010. Before this process ends 2012, this plan is replicated or moved to alternative locations (primary and secondary contacts) for a “fault-tolerant” business process to respond to a canceled flight situation in the most expeditious means possible 2011.

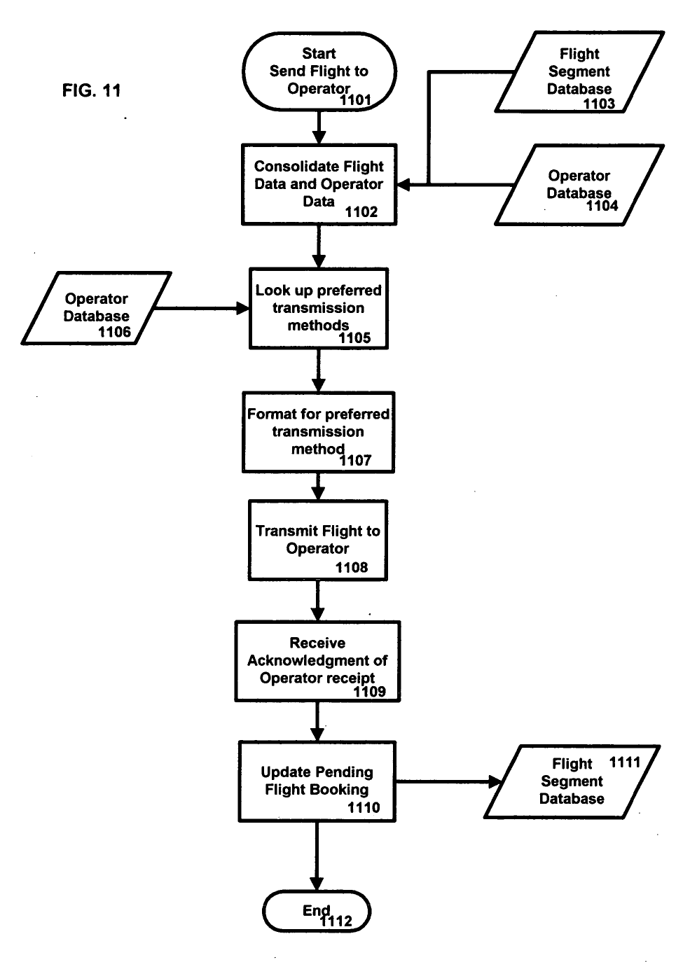

As illustrated in FIG. 11, the process 1100 of sending flight information to an operator starts 1101 with the consolidation of flight data and operator data 1102 with data from the flight segment and operator databases 1103, 1104. Using input from the operator database 1106, the preferred transmission method is looked up 1105 and the flight information is formatted for the preferred transmission method 1107. The flight information is transmitted to the operator 1108 and acknowledgement of the operator's receipt of the flight information is received 1109 before the pending flight booking is updated 1110 with the information stored in the flight segment database 1111 before the process ends 1112.

Payment by the passenger is an integral part of the overall process and a compensation method 1600 employing credit card payment is illustrated in FIG. 16. The credit card processing starts 1601 with looking up the passenger's credit card number in the passenger database 1602 and transmitting the credit card number to the billing processor 1603 which, in turn, contacts the credit card clearinghouse for an authorization number 1604. A billable amount appears on the end user statement 1605, the clearinghouse posts the amount to the central controller 1606, and the billing and payment database is updated to reflect completion of the billing obligation 1607. Next, the credit card number of the operator is looked up in the operator database 1608 and the credit card number is transmitted to the payment processor 1609 which, in turn, contacts the issuing bank to verify the status of the account 1610. The payment obligation is added to the operator's credit card account 1611 and the billing and payment databases are updated to reflect completion of the payment obligation 1612 before the process ends 1613.

Although several embodiments have been described in detail for purposes of illustration, various modifications may be made without departing from the scope and spirit of the invention.

What is claimed:

1. A method and apparatus for a passenger to request an individual seat on a charter vehicle comprising:
a controller unit for receiving a passenger request generated by a passenger, the controller unit having a database for storing therein a plurality of qualifications for the passenger, a plurality of charter operators, a plurality of qualifications for other passengers, a plurality of future charter trips, and a plurality of previous charter trip information;
means for the passenger to receive a quote for an individual seat for the trip on at least one of the following, a charter aircraft, a charter bus, a charter van or a charter car;
means for the passenger to select a charter trip from a list of responses, book the trip and receive confirmation;
means to commit the charter operator to providing the requested travel services at the quoted price;
means to manage payment from the passenger;
means to manage payment to the charter operator;
means for a controller unit to calculate optimized routes for passengers and charter operators for a plurality of time periods and a plurality of geographic areas;
means for a controller unit to aggregate passengers on charter trips to meet at least one charter operator's requirements consisting of vehicle utilization, occupancy rate, useful load by weight, intermediate stops, revenue per hour, and revenue per trip;
means for a controller unit to calculate passenger's fare and charter operator's costs for individual seats on a charter trip, using a database storing therein a plurality of information about trips and a second database storing a plurality of information about charter operators;
whereby a passenger is able to travel on the charter vehicle with at least one other passenger for substantially less fare compared to chartering the vehicle exclusively.

2. The apparatus of claim 1, wherein the charter operator qualifications are selected from the group consisting of address, location of base of operations, coverage area, experience, equipment, response times, rates, and certification rating from independent research firms.

3. The apparatus of claim 1, wherein the means for communicating, transmission and receipt, with the charter operator and the passenger includes an interface selected from the group consisting of an electronic network, the electronic network having at least one of a web page, a voice mail system, a voice response system, a facsimile system, a wireless internet Personal Digital Assistant (PDA), and a cell phone capable of running computer applications.

4. The apparatus of claim 1, wherein the database includes a memory device for storing charter operator qualifications in at least one of a text, video, and audio format.

5. The apparatus of claim 1, wherein a search means queries the database for charter operator qualifications which correspond to the passenger request.

6. The apparatus of claim 1, further comprising means to classify the passenger request.

7. The apparatus of claim 1, further comprising a means to calculate a schedule using calculations for a plurality of passengers, a plurality of charter operators, a plurality of constraints from passengers, charter operators and dependent third parties, meeting at least one of the following constraints, price, departure point, departure time, destination point, destination time, number of intermediate stops, aircraft type and total travel time.

8. The apparatus of claim 1, further comprising means for the passenger to select a charter operator from the search results.

9. The apparatus of claim 1, wherein the controller selects a charter operator from a subset of charter operators who respond to the passenger request transmitted by the controller unit to the charter operator based on selection criteria established by the passenger.

10. The apparatus of claim 1, further comprising means for transmitting charter operator qualifications to a passenger.

11. The apparatus of claim 1, further comprising means for transmitting route data to a passenger.

12. The apparatus of claim 1, further comprising means for storing and retrieving route data.

13. The apparatus of claim 1, wherein the payment collection means includes at least one of (i) a credit card system; (ii) digital cash; (iii) electronic funds transfer; and (iv) invoice billing.

14. The apparatus of claim 1, wherein the payment remittance means includes at least one of (i) a credit card system; (ii) digital cash; (iii) electronic funds transfer; and (iv) invoice billing.

15. The apparatus of claim 1, wherein the means for payment includes an algorithm for calculating the payment rate as a function of the route attributes.

16. The apparatus of claim 1, wherein the means for payment includes an algorithm for calculating the payment rate as a function of the charter operator qualifications.

17. The apparatus of claim 1, further comprising means for real time transmission of a passenger request to a charter operator address, and real time transmission of a charter operator answer to the passenger.

18. The apparatus of claim 17, further comprising means for storing and retrieving the direct communications between the passenger and the charter operator.

19. The apparatus of claim 1, further comprising a means for calculation of pricing to compute the optimal pricing for a plurality of passengers, a plurality of charter operators, within at least one of the following constraints (i) a geographic area; (ii) a time frame; (iii) a subset of routes; (iv) a subset of operators; (v) and a subset of passengers.

20. A computer implemented charter operator matching apparatus for managing communications between a charter operator, having particular qualifications, and a passenger with a travel request, comprising:
a controller unit for receiving a passenger request generated by a passenger, the controller unit having a database for storing therein a plurality of charter operator qualifications, each charter operator qualification associated with an address corresponding to a particular charter operator;
means for classifying the passenger request;
means for searching the database to generate a search result containing charter operator qualifications which correspond to the passenger request classification;
means for searching external databases for search results containing charter operator qualifications which correspond to the passenger request classification;
means for authenticating data communications between the controller unit and the charter operator;
means for authenticating data communications between the controller unit and the passenger;
means for transmitting at least a portion of the passenger request to the charter operator based on the search result;
means for receiving at least one charter operator answer responsive to the transmitted passenger request; and
means for transmitting at least a portion of the charter operator answer to the passenger.
